(19) United States
(12) Patent Application Publication
(10) Pub. No.: US 2025/0096873 A1
(43) Pub. Date: Mar. 20, 2025

(54) METHOD AND DEVICE IN NODES USED FOR WIRELESS COMMUNICATION

(71) Applicants: Lu WU, Shanghai (CN); Xiaobo ZHANG, Shanghai (CN)

(72) Inventors: Lu WU, Shanghai (CN); Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/970,942

(22) Filed: Dec. 6, 2024

Related U.S. Application Data
(63) Continuation of application No. PCT/CN2023/097912, filed on Jun. 2, 2023.

(30) Foreign Application Priority Data
Jun. 6, 2022 (CN) 202210634247.3

(51) Int. Cl. H04B 7/06; H04B 7/0456; H04W 72/0453

(52) U.S. Cl. CPC H04B 7/0626; H04B 7/0456; H04W 72/0453

(57) ABSTRACT

A first node receives a first information block, and transmits first CSI. The first information block is used to indicate a first RS resource set, a measurement on the first RS resource set is used to generate the first CSI, the first CSI comprises a first information set and a second information set, the first information set comprises at least one first-type information group, and the second information set comprises at least one information group; the first-type information group corresponds to a first bandwidth, and a priority of the first-type information group is higher than a priority of any information group in the second-type information set; first channel information belongs to the first CSI, a type of the first channel information is one of PMI or first type, and the first type is non-codebook-based.

### CROSS REFERENCE TO RELATED APPLICATIONS

This application is the continuation of the international patent application No. PCT/CN2023/097912, filed on Jun. 2, 2023, and claims the priority benefit of Chinese Patent Application 202210634247.3, filed on Jun. 6, 2022, the full disclosure of which is incorporated herein by reference.

### BACKGROUND

### Technical Field

The present application relates to transmission methods and devices in wireless communication systems, and in particular to a transmission method and device of a radio signal in a wireless communication system supporting cellular networks.

### Related Art

In traditional wireless communications, UE (User Equipment) reporting may comprise at least one of a variety of auxiliary information, such as CSI (Channel Status Information), Beam Management related auxiliary information, positioning related auxiliary information and so on. CSI comprises at least one of a CRI (CSI-RS Resource Indicator), an RI (Rank Indicator), a PMI (Precoding Matrix Indicator) or a CQI (Channel quality indicator). The network equipment selects appropriate transmission parameters for the UE according to the UE's reporting, such as a camping cell, an MCS (Modulation and Coding Scheme), a TPMI (Transmitted Precoding Matrix Indicator), a TCI (Transmission Configuration Indication) and other parameters. In addition, the UE's reporting can be used to optimize network parameters, such as better cell coverage, switching base stations according to UE location, etc. As the number of antennas increases, the traditional PMI feedback approach introduces a large amount of redundancy overhead, therefore, CSI compression based on AI (Artificial Intelligence) or ML (Machine Learning) was projected in NR R (release) 18.

In NR (New Radio) system, a priority of the CSI report is defined, and the priority is used to determine whether to assign CPU (CSI Processing Unit) resources to a corresponding CSI report for updating or whether to drop a corresponding CSI report.

### SUMMARY

The applicant has found through researches that determining the composition and priority of CSI reporting under different types is a key issue.

To address the above problem, the present application provides a solution. It should be noted that while a large number of embodiments of the present application are directed to AI/ML, the present application is also applicable to schemes based on traditional methods such as linear channel reconstruction; in particular, it is considered that the specific channel reconstruction algorithms are likely to be non-standardized or self-implemented by hardware equipment vendors. Further, the adoption of a unified UE reporting scheme can reduce implementation complexity or improve performance. If no conflict is incurred, embodiments in any node in the present application and the characteristics of the embodiments are also applicable to any other node. And the embodiments in the present application and the characteristics in the embodiments can be arbitrarily combined if there is no conflict.

In one embodiment, interpretations of the terminology in the present application refer to definitions given in the 3GPP TS36 series.

In one embodiment, interpretations of the terminology in the present application refer to definitions given in the 3GPP TS38 series.

In one embodiment, interpretations of the terminology in the present application refer to definitions given in the 3GPP TS37 series.

In one embodiment, interpretations of the terminology in the present application refer to definitions given in Institute of Electrical and Electronics Engineers (IEEE) protocol specifications.

The present application provides a method in a first node for wireless communications, comprising:
receiving a first information block; and
transmitting first Channel Status Information (CSI);
herein, the first information block is used to indicate a first Reference Signal (RS) resource set, the first RS resource set comprises at least one RS resource; a measurement on the first RS resource set is used to generate the first CSI, the first CSI comprises a first information set and a second information set, the first information set comprises at least one first-type information group, and the second information set comprises at least one information group; both the first-type information group and any information group in the second information set comprise at least one CSI report quantity, the first-type information group corresponds to a first bandwidth, and a priority of the first-type information group is higher than a priority of any information group in the second-type information set; first channel information belongs to the first CSI, and a type of the first channel information is either PMI (Precoding Matrix Indicator) or first type, where the PMI is codebook-based and the first type is non-codebook-based; the type of the first channel information is used to determine a number of the first-type information group(s) comprised in the first information set.

In one embodiment, the above method supports different types of channel information, and selecting the appropriate type can obtain more accurate channel information.

In one embodiment, the above method is compatible with traditional PMI methods and has good compatibility.

According to one aspect of the present application, it is characterized in that when the type of the first channel information is the first type, a measurement on the first RS resource set is used to generate an input of a first encoder, and an output of the first encoder is used to generate the first channel information.

According to one aspect of the present application, it is characterized in that a first frequency-domain resource group comprises frequency-domain resources which the first CSI is for; when the type of the first channel information is the first type, the first CSI comprises N1 channel information, the first channel information is any channel information in the N1 channel information, the first frequency-domain resource group comprises N1 frequency-domain resource subgroups, and frequency-domain resources which the N1 channel information are respectively for comprise the N1 frequency-domain resource subgroups respectively, N1 being a positive integer greater than 1; N1 outputs of the first encoder are respectively used to generate the N1 channel information.

According to one aspect of the present application, it is characterized in that the type of the first channel information is used to determine a type of the first bandwidth; when the type of the first channel information is PMI, the type of the first bandwidth is wideband; when the type of the first channel information is the first type, the type of the first bandwidth is different from wideband and sub-band.

According to one aspect of the present application, it is characterized in that the type of the first channel information is used to determine the first bandwidth; when the type of the first channel information is PMI, the first bandwidth is equal to a first value; when the type of the first channel information is the first type, the first bandwidth is equal to a second value.

According to one aspect of the present application, it is characterized in that when the type of the first channel information is PMI, the number of the first-type information group(s) comprised in the first information set is equal to 1; when the type of the first channel information is the first type, the first bandwidth is used to determine the number of the first-type information group(s) comprised in the first information set.

According to one aspect of the present application, it is characterized in that when the type of the first channel information is the first type, the first information set comprises N1 first-type information groups, the second information set comprises N2 information groups, both N1 and N2 being positive integers greater than 1, any of the N1 first-type information groups corresponds to at least one of the N2 information groups, and any of the N2 information groups corresponds to one of the N1 first-type information groups, the corresponding between the N2 information groups and the N1 first-type information groups is used to determine a priority order of the N2 information groups.

The present application provides a method in a second node for wireless communications, comprising:
transmitting a first information block; and
receiving first CSI (Channel Status Information);
herein, the first information block is used to indicate a first RS resource set, the first RS resource set comprises at least one RS resource; a measurement on the first RS resource set is used to generate the first CSI, the first CSI comprises a first information set and a second information set, the first information set comprises at least one first-type information group, and the second information set comprises at least one information group; both the first-type information group and any information group in the second information set comprise at least one CSI report quantity, the first-type information group corresponds to a first bandwidth, and a priority of the first-type information group is higher than a priority of any information group in the second-type information set; first channel information belongs to the first CSI, and a type of the first channel information is either PMI or first type, where the PMI is codebook-based and the first type is non-codebook-based; the type of the first channel information is used to determine a number of the first-type information group(s) comprised in the first information set.

According to one aspect of the present application, it is characterized in that when the type of the first channel information is the first type, the first channel information is used to generate an input of a first decoder, and the first decoder is obtained through training.

According to one aspect of the present application, it is characterized in that a first frequency-domain resource group comprises frequency-domain resources which the first CSI is for; when the type of the first channel information is the first type, the first CSI comprises N1 channel information, the first channel information is any channel information in the N1 channel information, the first frequency-domain resource group comprises N1 frequency-domain resource subgroups, and frequency-domain resources which the N1 channel information are respectively for comprise the N1 frequency-domain resource subgroups respectively, N1 being a positive integer greater than 1; N1 outputs of the first encoder are respectively used to generate the N1 channel information.

According to one aspect of the present application, it is characterized in that the type of the first channel information is used to determine a type of the first bandwidth; when the type of the first channel information is PMI, the type of the first bandwidth is wideband; when the type of the first channel information is the first type, the type of the first bandwidth is different from wideband and sub-band.

According to one aspect of the present application, it is characterized in that the type of the first channel information is used to determine the first bandwidth; when the type of the first channel information is PMI, the first bandwidth is equal to a first value; when the type of the first channel information is the first type, the first bandwidth is equal to a second value.

According to one aspect of the present application, it is characterized in that when the type of the first channel information is PMI, the number of the first-type information group(s) comprised in the first information set is equal to 1; when the type of the first channel information is the first type, the first bandwidth is used to determine the number of the first-type information group(s) comprised in the first information set.

According to one aspect of the present application, it is characterized in that when the type of the first channel information is the first type, the first information set comprises N1 first-type information groups, the second information set comprises N2 information groups, both N1 and N2 being positive integers greater than 1, any of the N1 first-type information groups corresponds to at least one of the N2 information groups, and any of the N2 information groups corresponds to one of the N1 first-type information groups, the corresponding between the N2 information groups and the N1 first-type information groups is used to determine a priority order of the N2 information groups.

The present application provides a first node for wireless communications, comprising:
a first receiver, receiving a first information block; and
a first transmitter, transmitting first CSI;
herein, the first information block is used to indicate a first RS resource set, the first RS resource set comprises at least one RS resource; a measurement on the first RS resource set is used to generate the first CSI, the first CSI comprises a first information set and a second information set, the first information set comprises at least one first-type information group, and the second information set comprises at least one information group; both the first-type information group and any information group in the second information set comprise at least one CSI report quantity, the first-type information group corresponds to a first bandwidth, and a priority of the first-type information group is higher than a priority of any information group in the second-type information set; first channel information belongs to the first CSI, and a type of the first channel information is either PMI or first type, where the PMI is codebook-based and the first type is non-codebook-based; the type of the first channel information is used to determine a number of the first-type information group(s) comprised in the first information set.

The present application provides a second node for wireless communications, comprising:
a second transmitter, transmitting a first information; and
a second receiver, receiving first CSI;
herein, the first information block is used to indicate a first RS resource set, the first RS resource set comprises at least one RS resource; a measurement on the first RS resource set is used to generate the first CSI, the first CSI comprises a first information set and a second information set, the first information set comprises at least one first-type information group, and the second information set comprises at least one information group; both the first-type information group and any information group in the second information set comprise at least one CSI report quantity, the first-type information group corresponds to a first bandwidth, and a priority of the first-type information group is higher than a priority of any information group in the second-type information set; first channel information belongs to the first CSI, and a type of the first channel information is either PMI or first type, where the PMI is codebook-based and the first type is non-codebook-based; the type of the first channel information is used to determine a number of the first-type information group(s) comprised in the first information set.

In one embodiment, the present application has the following advantages over conventional schemes:
being compatible with traditional PMI methods and having good compatibility;
supporting different types of channel information;
selecting the appropriate type can obtain more accurate channel information.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of a first information block and first CSI according to one embodiment of the present application;

FIG. 2 illustrates a schematic diagram of a network architecture according to one embodiment of the present application;

FIG. 3 illustrates a schematic diagram of a radio protocol architecture of a user plane and a control plane according to one embodiment of the present application;

FIG. 4 illustrates a schematic diagram of hardware modules of a communication node according to one embodiment of the present application;

FIG. 5 illustrates a flowchart of wireless transmission according to one embodiment of the present application;

FIG. 6 illustrates a schematic diagram of a first type and a first encoder according to one embodiment of the present application;

FIG. 7 illustrates a schematic diagram of N1 channel information according to one embodiment of the present application;

FIG. 8 illustrates a schematic diagram of a type of a first bandwidth according to one embodiment of the present application;

FIG. 9 illustrates a flowchart of a relation of a type of a first bandwidth and a type of first channel information according to one embodiment of the present application;

FIG. 10 illustrates a schematic diagram of a number of first-type information group(s) comprised in a first information set according to one embodiment of the present application;

FIG. 11 illustrates a schematic diagram of a priority ranking of N2 information groups according to one embodiment of the present application;

FIG. 12 illustrates a schematic diagram of an artificial intelligence processing system according to one embodiment of the present application;

FIG. 13 illustrates a schematic diagram of a transmission of first channel information according to one embodiment of the present application;

FIG. 14 illustrates a schematic diagram of a first encoder according to one embodiment of the present application;

FIG. 15 illustrates a schematic diagram of a first function according to one embodiment of the present application;

FIG. 16 illustrates a schematic diagram of a decoding layer group according to one embodiment of the present application;

FIG. 17 illustrates a structure block diagram of a processor in a first node according to one embodiment of the present application;

FIG. 18 illustrates a structure block diagram of a processor in a second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

Embodiment 1 illustrates a flowchart of a first information block and first CSI according to one embodiment of the present application, as shown in FIG. 1. In 100 illustrated by FIG. 1, each box represents a step.

In Embodiment 1, the first node in the present application receives a first information block in step 101; transmits first CSI in step 102; herein, the first information block is used to indicate a first RS resource set, the first RS resource set comprises at least one RS resource; a measurement on the first RS resource set is used to generate the first CSI, the first CSI comprises a first information set and a second information set, the first information set comprises at least one first-type information group, and the second information set comprises at least one information group; both the first-type information group and any information group in the second information set comprise at least one CSI report quantity, the first-type information group corresponds to a first bandwidth, and a priority of the first-type information group is higher than a priority of any information group in the second-type information set; first channel information belongs to the first CSI, and a type of the first channel information is either PMI or first type, where the PMI is codebook-based and the first type is non-codebook-based; the type of the first channel information is used to determine a number of the first-type information group(s) comprised in the first information set.

In one embodiment, the first RS resource set comprises at least one downlink reference signal resource for channel measurement.

In one sub-embodiment of the above embodiment, a measurement for the first RS resource set comprises a channel measurement performed in the at least one downlink reference signal resource for channel measurement.

In one embodiment, the first RS resource set comprises at least one downlink reference signal resource for channel measurement and at least one downlink reference signal resource for interference measurement.

In one sub-embodiment of the above embodiment, a measurement for the first RS resource set comprises a channel measurement performed in the at least one downlink reference signal resource for channel measurement and an interference measurement performed in the at least one downlink reference signal resource for interference measurement.

In one embodiment, the first RS resource set comprises at least one CSI-RS (Channel Status Information Reference Signal) resource.

In one embodiment, any reference signal resource in the first RS resource set is a downlink RS resource.

In one embodiment, any RS resource in the first RS resource set is a CSI-RS resource.

In one embodiment, the first information block is carried by a higher-layer signaling.

In one embodiment, the first information block is carried by an RRC signaling.

In one embodiment, the first information block is carried by a MAC CE signaling.

In one embodiment, the first information block comprises at least one IE (Information Element).

In one embodiment, the first information block comprises an IE.

In one subembodiment of the above embodiment, a name of the IE comprises “CSI”.

In one subembodiment of the above embodiment, a name of the IE comprises “CSI-Report”.

In one subembodiment of the above embodiment, a name of the IE comprises “CSI-ReportConfig”.

In one embodiment, the first information block comprises a CSI-ReportConfig IE.

In one embodiment, the first information block comprises partial fields in an IE.

In one embodiment, the type of the first channel information is configured by the first information block.

In one embodiment, the first information block is used to configure the first CSI.

In one embodiment, the first information block is used to configure the first RS resource set.

In one embodiment, the first information block comprises an index of the first RS resource set.

In one embodiment, the first information block comprises configuration information of the first RS resource set.

In one embodiment, the first RS resource set is indicated by at least one of resourcesForChannelMeasurement, csi-IM-ResourcesForInterference, or nzp-CSI-RS-ResourcesForInterference in the first information block.

In one embodiment, configuration information of the first RS resource set comprises configuration information of each reference signal resource in the first RS resource set.

In one embodiment, configuration information of a reference signal resource is indicated by one or more IEs.

In one embodiment, configuration information of a reference signal resource comprises at least one of period, time offset, time-domain resources occupied, frequency-domain resources occupied, code-domain resources occupied, cyclic shift, Orthogonal Cover Code (OCC), antenna port group occupied, transmitting sequence or Transmission Configuration Indicator (TCI) state.

In one embodiment, the first CSI comprises at least one CSI report quantity, and the first information block indicates a type of each CSI report quantity comprised in the first CSI.

In one embodiment, the first information block comprises a first higher-layer parameter.

In one embodiment, the first information block comprises a second higher-layer parameter.

In one embodiment, the first information block comprises a first higher-layer parameter and a third higher-layer parameter.

In one embodiment, the first information block comprises a first higher-layer parameter and a second higher-layer parameter.

In one embodiment, the first information block comprises a first higher-layer parameter, a third higher-layer parameter and a second higher-layer parameter.

In one embodiment, the first higher-layer parameter indicates at least one reference signal resource, and the first RS resource set comprises the at least one reference signal resource indicated by the first higher-layer parameter; a channel measurement for calculating the first CSI is obtained based on the at least one reference signal resource indicated by the first higher-layer layer parameter.

In one embodiment, the third higher-layer parameter indicates at least one reference signal resource, and the first RS resource set comprises the at least one reference signal resource indicated by the third higher-layer parameter; the first node obtains an interference measurement for calculating the first CSI based on the at least one reference signal resource indicated by the third higher-layer parameter.

In one embodiment, the second higher-layer parameter indicates at least one reference signal resource, and the first RS resource set comprises the at least one reference signal resource indicated by the second higher-layer parameter; the first CSI comprises at least one CSI report quantity, and the second higher-layer parameter is used to determine each CSI report quantity comprised in the first CSI.

In one embodiment, a name of the first higher-layer parameter comprises resourcesForChannelMeasurement.

In one embodiment, a name of the first higher-layer parameter comprises Channel.

In one embodiment, a name of the third higher-layer parameter comprises ResourcesForInterference.

In one embodiment, a name of the third higher-layer parameter comprises Interference.

In one embodiment, a name of the second higher-layer parameter comprises reportQuantity.

In one embodiment, a name of the second higher-layer parameter comprises Quantity.

In one embodiment, the second higher-layer parameter indicates a type of each CSI report quantity comprised in the first CSI.

In one embodiment, the first information block is used to configure at least the first channel information.

In one embodiment, the first information block is used to indicate frequency-domain resources targeted by the first CSI.

In one embodiment, the first information block is used to indicate frequency-domain resources targeted by the first channel information.

In one embodiment, a given frequency-domain resource refers to frequency-domain resource targeted by given channel information, and the given channel information comprises channel information on the given frequency-domain resource.

In one subembodiment of the above embodiment, the given channel information is the first CSI.

In one subembodiment of the above embodiment, the given channel information is the first channel information.

In one subembodiment of the above embodiment, the given channel information is any of the N1 channel matrixes, and the given frequency-domain resource is one of the N1 frequency-domain resource subgroups.

In one embodiment, when a type of the first channel information is PMI, the first information block indicates a codebook type of the PMI.

In one embodiment, a codebook type of the PMI is Type I codebook, and the PMI is a Type I codebook index.

In one embodiment, a codebook type of the PMI is type II codebook, and the PMI is a type II codebook index.

In one embodiment, a codebook type of the PMI is an enhanced type II codebook, and the PMI is an enhanced type II codebook index.

In one embodiment, a codebook type of the PMI is a Further Enhanced Type II Port Selection codebook, and the PMI is a Further Enhanced Type II Port Selection codebook index.

In one embodiment, for specific definitions of the Type I codebook, the Type II codebook, the Enhanced Type II codebook, and the Further Enhanced Type II Port Selection codebook, refer to clause 5 of 3GPP TS 38.214.

In one embodiment, a physical-layer signaling triggers the first CSI.

In one embodiment, a DCI signaling triggers the first CSI.

In one embodiment, the first receiver receives a first signaling; herein, the first signaling is used to trigger the first CSI.

In one subembodiment of the above embodiment, the first signaling is a physical-layer signaling.

In one subembodiment of the above embodiment, the first signaling is a DCI signaling.

In one subembodiment of the above embodiment, the first signaling is a MAC CE signaling.

In one embodiment, the first signaling is a physical-layer signaling, the first signaling comprises a first field, and the first field in the first signaling triggers the first CSI; the first field comprises at least one bit.

In one subembodiment of the above embodiment, the first information block indicates that a reporting configuration type of the first CSI is aperiodic.

In one subembodiment of the above embodiment, the first information block indicates that a reporting configuration type of the first CSI is semi-persistent.

In one embodiment, the first signaling is a physical-layer signaling, the first signaling comprises a first field, the first field in the first signaling is used to indicate first CSI triggering state from a set of CSI triggering states, and the first CSI triggering state comprises the first information block.

In one subembodiment of the above embodiment, the first information block indicates that a reporting configuration type of the first CSI is aperiodic.

In one subembodiment of the above embodiment, the first information block indicates that a reporting configuration type of the first CSI is semi-persistent.

In one subembodiment of the above embodiment, the set of CSI triggering states comprises at least one CSI triggering state.

In one subembodiment of the above embodiment, the set of CSI triggering states comprises multiple CSI triggering states.

In one subembodiment of the above embodiment, the first field in the first signaling indicates an index of the first CSI triggering state in the set of CSI triggering states.

In one subembodiment of the above embodiment, a value of the first field in the first signaling is equal to an index of the first CSI triggering state in the set of CSI triggering states.

In one subembodiment of the above embodiment, the set of CSI triggering states is configured by an IE.

In one subembodiment of the above embodiment, the set of CSI triggering states is configured by a higher-layer parameter.

In one subembodiment of the above embodiment, the first information block indicates that a reporting configuration type of the first CSI is aperiodic, and the set of CSI triggering states is configured by a CSI-AperiodicTriggerStateList IE.

In one subembodiment of the above embodiment, the first information block indicates that a reporting configuration type of the first CSI is semi-persistent, and the set of CSI triggering states is configured by CSI-SemiPersistentOnPUSCH-TriggerStateList.

In one embodiment, the first field is a CSI request field.

In one embodiment, for the specific definition of the CSI request field, refer to clause 7.3.1 in 3GPP TS38.212.

In one embodiment, for the specific meaning of the CSI triggering state, refer to clause 5.2.1.5 in 3GPP TS38.214.

In one embodiment, the first CSI comprises at least one CSI report quantity.

In one embodiment, the first CSI comprises at least one CSI report quantity, and a type of any CSI report quantity in the first CSI is one type in a first-type set.

In one embodiment, the first CSI comprises at least one CSI report quantity, and the at least one CSI report quantity in the first CSI at least comprises PMI or the first type.

In one embodiment, the first-type set comprises PMI and the first type.

In one embodiment, the first-type set comprises at least PMI and the first type in PMI (Precoding Matrix Indicator), the first type, CQI (Channel Quality Indicator), CRI (CSI-RS Resource Indicator), LI (Layer Indicator), RI (Rank Indicator), SSBRI (SS/PBCH Block Resource Indicator), L1-RSRP (Layer 1-Reference Signal received power) or L1-SINR (Layer 1-Signal to Interference and Noise Ratio).

In one embodiment, a measurement for the first RS resource set comprises a channel measurement used to calculate at least one CSI report quantity in the first CSI reporting.

In one embodiment, a measurement for the first RS resource set comprises an interference measurement used to calculate at least one CSI report quantity in the first CSI reporting.

In one embodiment, a measurement for the first RS resource set comprises a channel measurement and an interference measurement used to calculate at least one CSI report quantity in the first CSI reporting.

In one embodiment, the first-type information group comprises a CSI report quantity of the first CSI.

In one embodiment, the first-type information group comprises at least one CSI report quantity of the first CSI.

In one embodiment, a type of the first-type information group comprises at least one type in the first-type set.

In one embodiment, a type of the first-type information group is a type in the first-type set.

In one embodiment, any information group in the second information set comprises a CSI report quantity of the first CSI.

In one embodiment, any information group in the second information set comprises at least one CSI report quantity of the first CSI.

In one embodiment, a type of any information group in the second information set comprises at least one type in the first-type set.

In one embodiment, a type of any information group in the second information set is one type in the first-type set.

In one embodiment, the second information set comprises only one information group.

In one embodiment, the second information set comprises more than one information group.

In one embodiment, when the type of the first channel information is PMI, the number of the first-type information group(s) comprised in the first information set is equal to 1, and a number of information group(s) comprised in the second information set is equal to 2.

In one embodiment, when the type of the first channel information is PMI, a first-type information group comprises wideband CSI, and any information group in the second information set comprises CSI of at least one sub-band.

In one embodiment, when the type of the first channel information is PMI, a first-type information group comprises wideband CSI, and the second information set comprises two information groups, and the two information groups in the second information set respectively comprise CSI for all odd sub-bands and CSI for all even sub-bands.

In one embodiment, when the type of the first channel information is PMI, the type of the first bandwidth is wideband, and the type of the second bandwidth is sub-band.

In one embodiment, when the type of the first channel information is PMI, the first-type information group is Part 2 wideband CSI, and any information group in the second information set is Part 2 sub-band CSI.

In one embodiment, when the type of the first channel information is PMI, the second information set comprises two information groups, the two information groups in the second information set respectively comprise Part 2 sub-band CSI for all even sub-bands and Part 2 sub-band CSI for all odd sub-bands, where a priority of the Part 2 sub-band CSI for all even sub-bands is higher than a priority of Part 2 sub-band CSI for any odd sub-band.

In one embodiment, the first-type information group is Group 0 CSI, and the second information set comprises two information groups, the two information groups in the second information set are Group 1 CSI and Group 2 CSI, respectively, and a priority of the Group 1 CSI is higher than a priority of the Group 2 CSI.

In one embodiment, for the specific definitions of the Part 2 wideband CSI, the Part 2 sub-band CSI, the Group 0 CSI, the Group 1 CSI, and the Group 2 CSI, refer to clause 5.2.3 of 3GPP TS 38.214.

In one embodiment, a CSI report quantity comprised in the first-type information group and a CSI report quantity comprised in any information group in the second information set are different.

In one embodiment, the second information set comprises N2 information groups, where N2 is a positive integer greater than 1, and CSI reporting quantities comprised in at least two of the N2 information groups are the same.

In one embodiment, the second information set comprises N2 information groups, where N2 is a positive integer greater than 1, and CSI reporting quantities comprised in at least two of the N2 information groups are different.

In one embodiment, the second information set comprises N2 information groups, where N2 is a positive integer greater than 1, and CSI reporting quantities respectively comprised in the N2 information groups are the same.

In one embodiment, any information group in the second information set corresponds to a second bandwidth, and the first bandwidth is greater than the second bandwidth.

In one embodiment, at least one information group in the second information set corresponds to a second bandwidth, and the first bandwidth is greater than the second bandwidth.

In one embodiment, the meaning of the phrase that “the first-type information group corresponds to a first bandwidth” comprises: at least one CSI report quantity comprised in the first-type information group is for a first bandwidth.

In one embodiment, the meaning of the phrase that “the first-type information group corresponds to a first bandwidth” comprises: the first-type information group is used to determine CSI for a first bandwidth.

In one embodiment, the meaning of the phrase that “an information group in the second information set corresponds to a second bandwidth” comprises: at least one CSI report quantity comprised in one information group in the second information set is for a second bandwidth.

In one embodiment, the meaning of the phrase that “an information group in the second information set corresponds to a second bandwidth” comprises: an information group in the second information set is used to determine CSI for the second bandwidth.

In one embodiment, when the first information set comprises more than one first-type information group, priorities of all first-type information groups in the first information set are the same.

In one embodiment, priorities of all information groups in the second information set are different.

In one embodiment, priorities of any two information groups in the second information set are different.

In one embodiment, a priority of the first information set is higher than a priority of the second information set.

In one embodiment, a priority of the first information set is Priority 0.

In one embodiment, a priority of the first-type information group is Priority 0.

In one embodiment, the first information set comprises Priority 0 CSI.

In one embodiment, the first-type information group comprises Priority 0 CSI.

In one embodiment, a priority value of the first-type information group is 0, and a priority value of any information block in the second information set is greater than 0.

Typically, the smaller the priority value, the higher the corresponding priority.

In one embodiment, for the specific definition of the Priority 0, refer to clause 5.2.3 in 3GPP TS38.214.

In one embodiment, a first frequency-domain resource group comprises frequency-domain resources which the first CSI is for.

In one embodiment, a first BWP is a BWP to which the first RS resource set belongs, and a first frequency-domain resource group comprises partial or all frequency-domain resources in the first BWP.

In one embodiment, the first information block is used to indicate the first frequency-domain resource group.

In one embodiment, the first frequency-domain resource group is indicated by csi-ReportingBand in the first information block.

In one embodiment, the first frequency-domain resource group comprises multiple sub-bands.

In one embodiment, the first frequency-domain resource group comprises multiple RBs.

In one embodiment, any sub-band in the first frequency-domain resource group comprises at least one RB.

In one embodiment, the first frequency-domain resource group comprises N1 frequency-domain resource subgroups, where N1 is a positive integer greater than 1.

In one embodiment, any of the N1 frequency-domain resource subgroups comprises at least one sub-band in the first frequency-domain resource group.

In one embodiment, any of the N1 frequency-domain resource subgroups comprises at least one RB in the first frequency-domain resource group.

In one embodiment, bandwidths of the N1 frequency-domain resource subgroups are all the same.

In one embodiment, a number of RB(s) respectively comprised in each of the N1 frequency-domain resource subgroups is the same.

In one embodiment, numbers of RBs comprised in at least two of the N1 frequency-domain resource subgroups are the same.

In one embodiment, there exist numbers of RBs comprised in two frequency-domain resource subgroups in the N1 frequency-domain resource subgroups being different.

In one embodiment, any two of the N1 frequency-domain resource subgroups are orthogonal.

In one embodiment, at least two frequency-domain resource subgroups in the N1 frequency-domain resource subgroups are overlapping.

In one embodiment, the first CSI only comprises the first channel information.

In one embodiment, the first CSI also comprises information other than the first channel information.

In one embodiment, a type of the first channel information comprises at least one type in the first-type set.

In one embodiment, a type of the first-channel information is a type in the first-type set.

In one embodiment, a type of the information other than the first channel information comprises at least one type in the first-type set.

In one embodiment, a type of the information other than the first channel information comprises a PMI in the first-type set and at least one type other than the first type.

In one embodiment, the first channel information comprises the first information set and the second information set.

In one embodiment, the first channel information comprises at least one first-type information group in the first information set and the at least one information group in the second information set.

In one embodiment, the first channel information comprises only one first-type information group in the first information set and at least one information group in the second information set.

In one embodiment, the first channel information comprises only one first-type information group in the first information set and only one information group in the second information set.

In one embodiment, the first channel information comprises a reference information group in the first information set and all information groups corresponding to the reference information group in the second information set, wherein the reference information group is a first-type information group.

In one embodiment, the first channel information comprises a CSI report quantity of the first CSI.

In one embodiment, the first channel information comprises at least one CSI report quantity of the first CSI.

In one embodiment, when the type of the first channel information is the first type, the first CSI comprises at least one channel information, and the first channel information is any channel information in the at least one channel information.

In one embodiment, when the type of the first channel information is the first type, the first CSI comprises N1 channel information, and the first channel information is any one of the N1 channel information, where N1 is a positive integer greater than 1.

In one embodiment, the first frequency-domain resource group comprises N1 frequency-domain resource subgroups, and frequency-domain resources targeted by the N1 channel information each comprise the N1 frequency-domain resource subgroups.

In one embodiment, types of CSI reportings respectively comprised in the N1 channel information are all the same.

In one embodiment, types of N1 channel information are all the same.

In one embodiment, the first channel information is used to determine a phase, amplitude, or coefficient between at least two antenna ports.

In one embodiment, the first channel information is used to determine at least one eigenvector.

In one embodiment, the first channel information is used to determine at least one eigenvector.

In one embodiment, the first channel information is used to determine at least one pre-coding matrix.

In one embodiment, the first channel information is used to determine at least one channel matrix.

In one embodiment, when the type of the first channel information is PMI, a receiver of the first CSI determines a codebook index or precoding matrix recommended by the first node according to at least the first channel information.

In one embodiment, when a type of the first channel information is PMI, the first channel information is used to determine a codebook-based precoding matrix.

In one embodiment, when a type of the first channel information is the first type, the first channel information is used to determine a non-codebook-based precoding matrix.

In one embodiment, a bandwidth of frequency-domain resources targeted by the first channel information is not greater than the first bandwidth.

In one embodiment, a bandwidth of frequency-domain resources targeted by the first channel information is equal to the first bandwidth.

In one embodiment, a bandwidth of frequency-domain resources targeted by the first channel information belongs to the first frequency-domain resource group.

In one embodiment, the first CSI comprises N1 channel information, and the first channel information is one of the N1 channel information, N1 being a positive integer greater than 1.

In one embodiment, the first channel information comprises at least one of partial or all information in the first information set or partial or all information in the second information set.

In one embodiment, the first channel information comprises partial or all information in the first information set.

In one embodiment, the first channel information comprises partial or all information in the first information set and partial or all information in the second information set.

In one embodiment, the N1 channel information is transmitted on a physical-layer channel.

In one embodiment, the first CSI is transmitted on a physical-layer channel.

In one embodiment, the physical-layer channel is a PUSCH (Physical Uplink Shared Channel).

In one embodiment, the physical-layer channel is a PUCCH (Physical Uplink Control Channel).

In one embodiment, the meaning of the phrase that “the PMI is codebook-based” comprises: the PMI is selected from a candidate codebook set.

In one embodiment, the meaning of the phrase that “the PMI is codebook-based” comprises: the PMI indicates at least one codebook index.

In one embodiment, the meaning of the phrase that “the PMI is codebook-based” comprises: the PMI indicates a codebook-based pre-coding matrix.

In one embodiment, the meaning of the phrase that “the first type is non-codebook-based” comprises: the first type indicates non-codebook-based channel information.

In one embodiment, the meaning of the phrase that “the first type is non-codebook-based” comprises: the first type indicates channel information generated based on artificial intelligence or machine learning.

In one embodiment, channel information generated based on artificial intelligence or machine learning is non-codebook-based.

In one embodiment, the meaning of “a channel information being non-codebook-based” comprises: a channel matrix recovered by a receiver of the channel information according to the channel information is not available to a transmitter of the channel information.

In one embodiment, the meaning of “a channel information being non-codebook-based” comprises: the channel information is used for precoding, and the channel information does not comprise a codebook index.

In one embodiment, the non-codebook-based channel information refers to not being indicated by PMI or not being selected from a candidate codebook set.

In one embodiment, the non-codebook-based channel information is used for precoding.

In one embodiment, the non-codebook-based channel information is used to determine a channel matrix.

In one embodiment, the non-codebook-based channel information is used to determine phase, amplitude, or coefficient between at least two antenna ports.

In one embodiment, the non-codebook-based channel information is used to determine at least one eigenvector.

In one embodiment, the non-codebook-based channel information is used to determine at least one eigenvalue.

In one embodiment, the non-codebook-based channel information is used to determine at least one pre-coding matrix.

In one embodiment, the non-codebook-based channel information is used to determine at least one channel matrix.

### Embodiment 2

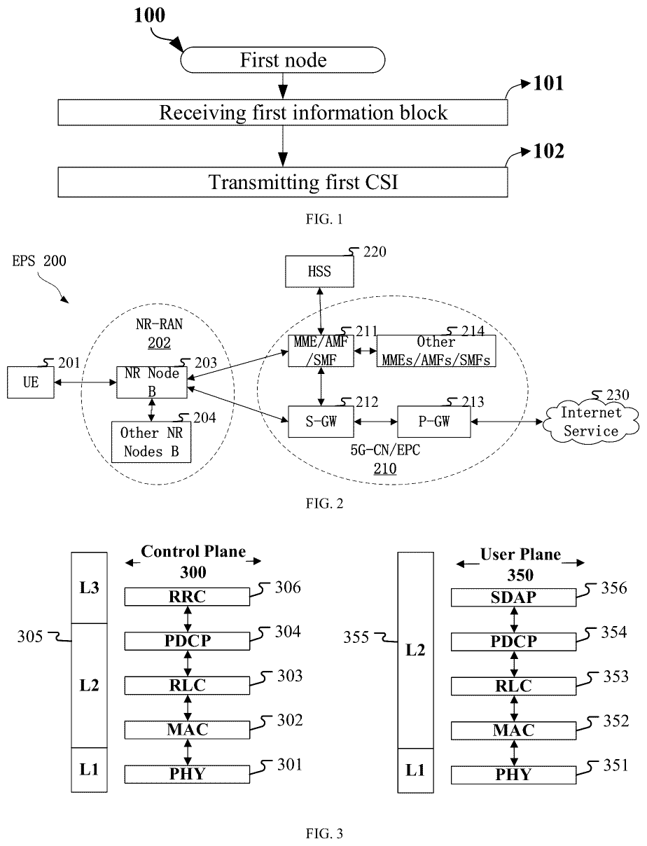

Embodiment 2 illustrates a schematic diagram of a network architecture according to one embodiment of the present application, as shown in FIG. 2. FIG. 2 illustrates the system architecture of 5G NR (New Radio), LTE (Long Term Evolution), and LTE-A (Long Term Evolution Advanced). The 5G NR or LTE network architecture 200 may be called a 5G System/Evolved Packet System (5GS/EPS) 5 or other appropriate terms. The EPS 200 may comprise UE 201, an NG-RAN 202, an Evolved Packet Core/5G-Core Network (EPC/5G-CN) 210, a Home Subscriber Server (HSS) 220 and an Internet Service 230. The EPS 200 may be interconnected with other access networks. For simple description, the entities/interfaces are not shown. As shown in FIG. 2, the EPS 200 provides packet switching services. Those skilled in the art will readily understand that various concepts presented throughout the present application can be extended to networks providing circuit switching services or other cellular networks. The NG-RAN 202 comprises an NR node B (gNB) 203 and other gNBs 204. The gNB 203 provides UE 201-oriented user plane and control plane protocol terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the EPC/5G-CN 210 for the UE 201. Examples of the UE 201 include cellular phones, smart phones, Session Initiation Protocol (SIP) phones, laptop computers, Personal Digital Assistant (PDA), satellite Radios, non-terrestrial base station communications, Satellite Mobile Communications, Global Positioning Systems (GPSs), multimedia devices, video devices, digital audio players (for example, MP3 players), cameras, game consoles, unmanned aerial vehicles (UAV), aircrafts, narrow-band Internet of Things (IoT) devices, machine-type communication devices, land vehicles, automobiles, wearable devices, or any other similar functional devices. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the EPC/5G-CN 210 via an Sl/NG interface. The EPC/5G-CN 210 comprises a Mobility Management Entity (MME)/Authentication Management Field (AMF)/User Plane Function (UPF) 211, other MMEs/AMFs/UPFs 214, a Service Gateway (S-GW) 212 and a Packet Date Network Gateway (P-GW) 213. The MME/AMF/UPF 211 is a control node for processing a signaling between the UE 201 and the EPC/5G-CN 210. Generally, the MME/AMF/UPF 211 provides bearer and connection management. All user Internet Protocol (IP) packets are transmitted through the S-GW 212, the S-GW 212 is connected to the P-GW 213. The P-GW 213 provides UE IP address allocation and other functions. The P-GW 213 is connected to the Internet Service 230. The Internet Service 230 comprises IP services corresponding to operators, specifically including Internet, Intranet, IP Multimedia Subsystem (IMS) and Packet Switching Streaming Services (PSS).

In one embodiment, the UE 201 corresponds to the first node in the present application, and the gNB 203 corresponds to the second node in the present application.

In one embodiment, the UE 201 supports generating reporting using AI (Artificial Intelligence) or Machine Learning.

In one embodiment, the UE 201 supports using training data to generate a trained model or using the trained data to generate partial parameters in the trained model.

In one embodiment, the UE 201 supports determining at least partial parameters of CNN (Conventional Neural Networks) used for CSI reconstruction through training.

In one embodiment, the UE 201 is a terminal that supports MIMO.

In one embodiment, the gNB 203 supports MIMO-based transmission.

In one embodiment, the gNB 203 supports decompression for CSI using AI or deep learning.

In one embodiment, the gNB 203 is a MarcoCellular base station.

In one embodiment, the gNB 203 is a Micro Cell base station.

In one embodiment, the gNB 203 is a PicoCell base station.

In one embodiment, the gNB 203 is a Femtocell.

In one embodiment, the gNB 203 is a base station that supports large delay differences.

In one embodiment, the gNB 203 is a flight platform.

In one embodiment, the gNB 203 is satellite equipment.

In one embodiment, the first node and the second node in the present application are respectively the UE 201 and the gNB 203.

### Embodiment 3

Embodiment 3 illustrates a schematic diagram of an example of a radio protocol architecture of a user plane and a control plane according to one embodiment of the present application, as shown in FIG. 3. FIG. 3 is a schematic diagram illustrating an embodiment of a radio protocol architecture of a user plane 350 and a control plane 300. In FIG. 3, the radio protocol architecture for a control plane 300 between a first node (UE or RSU in V2X, vehicle equipment or On-Board Communication Unit) and a second node (gNB, UE or RSU in V2X, vehicle equipment or On-Board Communication Unit), or between two UEs is represented by three layers, which are respectively layer 1, layer 2 and layer 3. The layer 1 (L1) is the lowest layer and performs signal processing functions of various PHY layers. The L1 is called PHY 301 in the present application. The layer 2 (L2) 305 is above the PHY 301, and is in charge of the link between the first node and the second node, and between two UEs via the PHY 301. The L2 305 comprises a Medium Access Control (MAC) sublayer 302, a Radio Link Control (RLC) sublayer 303 and a Packet Data Convergence Protocol (PDCP) sublayer 304. All the three sublayers terminate at the second nodes. The PDCP sublayer 304 provides data encryption and integrity protection and provides support for handover of a first node between second nodes. The RLC sublayer 303 provides segmentation and reassembling of a packet, retransmission of a lost data packet through ARQ, as well as repeat data packet detection and protocol error detection. The MAC sublayer 302 provides mapping between a logic channel and a transport channel and multiplexing of the logical channel. The MAC sublayer 302 is also responsible for allocating between first nodes various radio resources (i.e., resource block) in a cell. The MAC sublayer 302 is also responsible for HARQ operations. In the control plane 300, the RRC sublayer 306 in the L3 layer is responsible for acquiring radio resources (i.e., radio bearer) and configuring the lower layer using an RRC signaling between the second node and the first node. The radio protocol architecture in the user plane 350 comprises the L1 layer and the L2 layer. In the user plane 350, the radio protocol architecture used for the first communication node and the second communication node in a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 layer 355 in the user plane 350 also includes Service Data Adaptation Protocol (SDAP) sublayer 356, which is responsible for the mapping between QoS flow and Data Radio Bearer (DRB) to support the diversity of traffic. Although not described in FIG. 3, the first node may comprise several higher layers above the L2 305, such as a network layer (i.e., IP layer) terminated at a P-GW of the network side and an application layer terminated at the other side of the connection (i.e., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the first information block in the present application is generated by the MAC sublayer 302 or the MAC sublayer 352.

In one embodiment, the first information block in the present application is generated by the RRC sublayer 306.

In one embodiment, the first CSI in the present application is generated by the PHY 301 or the PHY 351.

### Embodiment 4

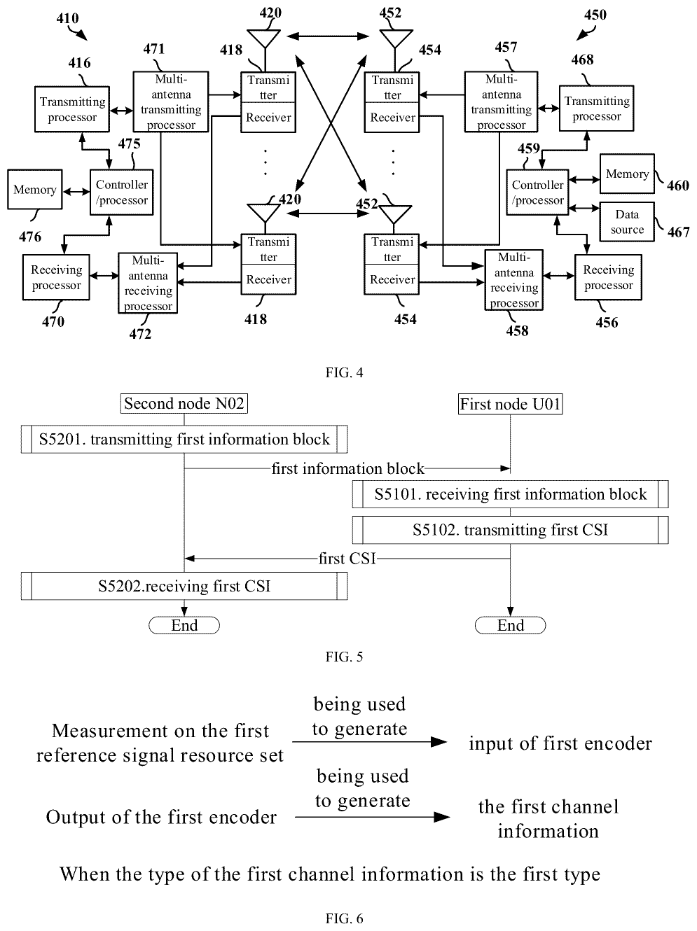

Embodiment 4 illustrates a schematic diagram of hardware modules of a communication node according to one embodiment of the present application, as shown in FIG. 4. FIG. 4 is a block diagram of a first communication device 450 in communication with a second communication device 410 in an access network.

The first communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

The second communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

In a transmission from the second communication device 410 to the first communication device 450, at the first communication device 410, a higher layer packet from the core network is provided to a controller/processor 475. The controller/processor 475 provides a function of the L2 layer. In the transmission from the second communication device 410 to the first communication device 450, the controller/processor 475 provides header compression, encryption, packet segmentation and reordering, and multiplexing between a logical channel and a transport channel, and radio resources allocation for the first communication device 450 based on various priorities. The controller/processor 475 is also responsible for retransmission of a lost packet and a signaling to the first communication device 450. The transmitting processor 416 and the multi-antenna transmitting processor 471 perform various signal processing functions used for the L1 layer (that is, PHY). The transmitting processor 416 performs channel coding and interleaving so as to ensure an FEC (Forward Error Correction) at the second communication device 450, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multi-carrier symbol streams. After that the multi-antenna transmitting processor 471 performs transmission analog precoding/beamforming on the time-domain multi-carrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the second communication device 410 to the first communication device 450, at the second communication device 450, each receiver 454 receives a signal via a corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any the first communication device-targeted spatial stream. Symbols on each spatial stream are demodulated and recovered in the receiving processor 456 to generate a soft decision. Then the receiving processor 456 de-interleaves and channel decodes the soft decision to recover the higher-layer data and control signal transmitted on the physical channel by the second communication node 410. Next, the higher-layer data and control signal are provided to the controller/processor 459. The controller/processor 459 performs functions of the L2 layer. The controller/processor 459 can be connected to a memory 460 that stores program code and data. The memory 460 can be called a computer readable medium. In the transmission from the second communication device 410 to the second node 450, the controller/processor 459 provides demultiplexing between a transport channel and a logical channel, packet reassembling, decryption, header decompression and control signal processing so as to recover a higher-layer packet from the core network. The higher-layer packet is later provided to all protocol layers above the L2 layer, or various control signals can be provided to the L3 layer for processing.

In a transmission from the first communication device 450 to the second communication device 410, at the second communication device 450, the data source 467 is configured to provide a higher-layer packet to the controller/processor 459. The data source 467 represents all protocol layers above the L2 layer. Similar to a transmitting function of the second communication device 410 described in the transmission from the second communication device 410 to the first communication device 450, the controller/processor 459 performs header compression, encryption, packet segmentation and reordering, and multiplexing between a logical channel and a transport channel based on radio resources allocation so as to provide the L2 layer functions used for the user plane and the control plane. The controller/processor 459 is also responsible for retransmission of a lost packet, and a signaling to the second communication device 410. The transmitting processor 468 performs channel coding, interleaving, and modulation mapping. The multi-antenna transmitting processor 457 implements digital multi-antenna spatial precoding, including codebook-based precoding and non-codebook-based precoding, as well as beamforming. Following that, the generated spatial streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the first communication device 450 to the second communication device 410, the function at the second communication device 410 is similar to the receiving function at the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides functions of the L2 layer. The controller/processor 475 can be connected with the memory 476 that stores program code and data. The memory 476 can be called a computer readable medium. In the transmission from the first communication device 450 to the second communication device 410, the controller/processor 475 provides de-multiplexing between a transport channel and a logical channel, packet reassembling, decryption, header decompression, control signal processing so as to recover a higher-layer packet from the UE 450. The higher-layer packet coming from the controller/processor 475 may be provided to the core network.

In one embodiment, the first communication device 450 comprises: at least one processor and at least one memory. The at least one memory comprises computer program codes; the at least one memory and the computer program codes are configured to be used in collaboration with the at least one processor, the first communication device 450 at least: receives a first information block; a first transmitter transmits first CSI; herein, the first information block is used to indicate a first RS resource set, the first RS resource set comprises at least one RS resource; a measurement on the first RS resource set is used to generate the first CSI, the first CSI comprises a first information set and a second information set, the first information set comprises at least one first-type information group, and the second information set comprises at least one information group; both the first-type information group and any information group in the second information set comprise at least one CSI report quantity, the first-type information group corresponds to a first bandwidth, and a priority of the first-type information group is higher than a priority of any information group in the second-type information set; first channel information belongs to the first CSI, and a type of the first channel information is either PMI or first type, where the PMI is codebook-based and the first type is non-codebook-based; the type of the first channel information is used to determine a number of the first-type information group(s) comprised in the first information set.

In one embodiment, the first communication device 450 comprises at least one processor and at least one memory. a memory that stores a computer readable instruction program. The computer readable instruction program generates an action when executed by at least one processor. The action includes: receiving a first information block; a first transmitter transmitting first CSI; herein, the first information block is used to indicate a first RS resource set, the first RS resource set comprises at least one RS resource; a measurement on the first RS resource set is used to generate the first CSI, the first CSI comprises a first information set and a second information set, the first information set comprises at least one first-type information group, and the second information set comprises at least one information group; both the first-type information group and any information group in the second information set comprise at least one CSI report quantity, the first-type information group corresponds to a first bandwidth, and a priority of the first-type information group is higher than a priority of any information group in the second-type information set; first channel information belongs to the first CSI, and a type of the first channel information is either PMI or first type, where the PMI is codebook-based and the first type is non-codebook-based; the type of the first channel information is used to determine a number of the first-type information group(s) comprised in the first information set.

In one embodiment, the second communication device 410 comprises at least one processor and at least one memory. The at least one memory comprises computer program codes; the at least one memory and the computer program codes are configured to be used in collaboration with the at least one processor. The second communication device 410 at least: transmits a first information block; receives first CSI; herein, the first information block is used to indicate a first RS resource set, the first RS resource set comprises at least one RS resource; a measurement on the first RS resource set is used to generate the first CSI, the first CSI comprises a first information set and a second information set, the first information set comprises at least one first-type information group, and the second information set comprises at least one information group; both the first-type information group and any information group in the second information set comprise at least one CSI report quantity, the first-type information group corresponds to a first bandwidth, and a priority of the first-type information group is higher than a priority of any information group in the second-type information set; first channel information belongs to the first CSI, and a type of the first channel information is either PMI or first type, where the PMI is codebook-based and the first type is non-codebook-based; the type of the first channel information is used to determine a number of the first-type information group(s) comprised in the first information set.

In one embodiment, the second communication device 410 comprises a memory that stores a computer readable instruction program. The computer readable instruction program generates an action when executed by at least one processor. The action includes: transmitting a first information block; receiving first CSI; herein, the first information block is used to indicate a first RS resource set, the first RS resource set comprises at least one RS resource; a measurement on the first RS resource set is used to generate the first CSI, the first CSI comprises a first information set and a second information set, the first information set comprises at least one first-type information group, and the second information set comprises at least one information group; both the first-type information group and any information group in the second information set comprise at least one CSI report quantity, the first-type information group corresponds to a first bandwidth, and a priority of the first-type information group is higher than a priority of any information group in the second-type information set; first channel information belongs to the first CSI, and a type of the first channel information is either PMI or first type, where the PMI is codebook-based and the first type is non-codebook-based; the type of the first channel information is used to determine a number of the first-type information group(s) comprised in the first information set.

In one embodiment, the first communication device 450 corresponds to a first node in the present application.

In one embodiment, the second communication device 410 corresponds to a second node in the present application.

In one embodiment, the first communication device 450 is a UE, and the second communication device 410 is a base station.

In one embodiment, at least one of the antenna 452, the receiver 454, the receiving processor 456, the multi-antenna receiving processor 458, the controller/processor 459, the memory 460, or the data source 467 is used to receive the first information block in the present application; at least one of the antenna 420, the transmitter 418, the transmitting processor 416, the multi-antenna transmitting processor 471, the controller/processor 475, or the memory 476 is used to transmit the first information block in the present application.

In one embodiment, at least one of the antenna 452, the transmitter 454, the transmitting processor 468, the multi-antenna transmitting processor 457, the controller/processor 459, or the memory 460 is used to transmit the first CSI in the present application; at least one of the antenna 420, the receiver 418, the receiving processor 470, the multi-antenna receiving processor 472, the controller/processor 475, or the memory 476 is used to receive the first CSI in the present application.

In one embodiment, the antenna 452, the receiver 454, the multi-antenna receiving processor 458 and the receiving processor 456 are used to receive the first information block in the present application.

In one embodiment, the controller/processor 459 is used to receive the first information block in the present application.

In one embodiment, the controller/processor 459 is used to generate the first CSI in the present application.

In one embodiment, the antenna 452, the transmitter 454, the multi-antenna transmitting processor 457, the transmitting processor 468 and the controller/processor 459 are used to transmit the first CSI in the present application.

In one embodiment, the antenna 420, the transmitter 418, the multi-antenna transmitting processor and the transmitting processor 416 are used to transmit the first information block in the present application.

In one embodiment, the controller/processor 475 is used to transmit the first information block in the present application.

In one embodiment, the antenna 420, the receiver 418, the multi-antenna receiving processor 472, the receiving processor 470 and the controller/processor 475 is used to receive the first CSI in the present application.

### Embodiment 5

Embodiment 5 illustrates a flowchart of wireless transmission according to one embodiment in the present application, as shown in FIG. 5. In FIG. 5, a first node U01 and a second node N02 are respectively communication nodes transmitted via an air interface.

The first node U01 receives a first information block in step S5101; transmits first CSI in step S5102;

The second node N02 transmits a first information block in step S5201; receives first CSI in step S5202;

In embodiment 5, the first information block is used to indicate a first RS resource set, the first RS resource set comprises at least one RS resource; a measurement on the first RS resource set is used to generate the first CSI, the first CSI comprises a first information set and a second information set, the first information set comprises at least one first-type information group, and the second information set comprises at least one information group; both the first-type information group and any information group in the second information set comprise at least one CSI report quantity, the first-type information group corresponds to a first bandwidth, and a priority of the first-type information group is higher than a priority of any information group in the second-type information set; first channel information belongs to the first CSI, and a type of the first channel information is either PMI or first type, where the PMI is codebook-based and the first type is non-codebook-based; the type of the first channel information is used to determine a number of the first-type information group(s) comprised in the first information set.

Typically, the first receiver receives at least one reference signal on the first RS resource set.

Typically, the first receiver receives the first RS resource set.

Typically, a method in the first node comprises:
receiving the first RS resource set.

Typically, a method in the first node comprises:
receiving at least one reference signal on the first RS resource set.

Typically, the second transmitter transmits at least one reference signal on the first RS resource set.

Typically, the second transmitter transmits the first RS resource set.

Typically, a method in the second node comprises:
transmitting the first RS resource set.

Typically, a method in the second node comprises:
transmitting at least one reference signal on the first RS resource set.

In one embodiment, when the type of the first channel information is PMI, the number of the first-type information group(s) comprised in the first information set is equal to 1.

In one embodiment, the meaning of the phrase that “the type of the first channel information is used to determine a number of the first-type information group(s) comprised in the first information set” comprises: the type of the first channel information is used to determine whether a number of the first-type information group(s) comprised in the first information set is fixed at 1.

In one embodiment, the meaning of the phrase that “the type of the first channel information is used to determine a number of the first-type information group(s) comprised in the first information set” comprises: the type of the first channel information is used to determine whether a number of the first-type information group(s) comprised in the first information set is a fixed value.

In one embodiment, the type of the first channel information is also used to determine a number of information group(s) comprised in the second information set.

In one embodiment, when the type of the first channel information is PMI, the number of the first-type information group(s) comprised in the first information set is equal to 1, and a number of information group(s) comprised in the second information set is equal to 2.

In one embodiment, the meaning of the phrase that “the type of the first channel information is also used to determine a number of information group(s) comprised in the second information set” comprises: the type of the first channel information is used to determine whether a number of information group(s) comprised in the second information set is fixed at 2.

In one embodiment, the meaning of the phrase that “the type of the first channel information is also used to determine a number of information group(s) comprised in the second information set” comprises: the type of the first channel information is used to determine whether a number of information group(s) comprised in the second information set is fixed.

### Embodiment 6

Embodiment 6 illustrates a schematic diagram of a first type and a first encoder according to one embodiment of the present application, as shown in FIG. 6.

In embodiment 6, when the type of the first channel information is the first type, a measurement on the first RS resource set is used to generate an input of a first encoder, and an output of the first encoder is used to generate the first channel information.

In one embodiment, a method in the first node comprises:
when the type of the first channel information is the first type, using a first encoder to generate the first channel information.

In one embodiment, when the type of the first channel information is the first type, the first receiver uses a first encoder to generate the first channel information.

In one embodiment, when the type of the first channel information is the first type, the first transmitter uses a first encoder to generate the first channel information.

In one embodiment, when the type of the first channel information is the first type, at least one of the first receiver or the first transmitter uses a first encoder to generate the first channel information.

In one embodiment, the first encoder is obtained through training.

In one embodiment, the training of the first encoder is performed at the first node.

In one embodiment, the training of the first encoder is performed by a transmitter of the first information block.

Typically, when the type of the first channel information is the first type, the first channel information is generated based on artificial intelligence methods.

Typically, when the type of the first channel information is the first type, a first encoder is used to generate the first channel information, and the first encoder is obtained based on training.

In one embodiment, the first matrix group is only available for the first node.

In one embodiment, the measurement for the first RS resource set is used to generate a first matrix group, the first matrix group is used to generate the first channel information, and the first matrix group comprises at least one channel matrix.

In one embodiment, the measurement for the first RS resource set is used to generate a first matrix group, and the first matrix group comprises at least one channel matrix; an output of the first encoder obtained by inputting a first channel matrix into the first encoder is used to generate the first channel information, and the first channel matrix is a channel matrix in the first matrix group.

In one embodiment, the specific implementation method of the first channel matrix is implemented by the hardware device manufacturer themselves.

In one embodiment, at least one channel matrix estimated for the measurement of the first RS resource set consists of the first channel matrix.

In one embodiment, at least one eigenvector of at least one channel matrix estimated for the measurement of the first RS resource set consists of the first channel matrix.

In one embodiment, at least one precoding vector or precoding matrix that has most similar or has minimum NMSE to a channel estimated by the measurement for the first RS resource set is selected in a candidate codebook to consist the first channel matrix.

In one embodiment, the measurement for the first reference signal resource set is used to generate a first matrix group, and the first matrix group comprises at least one channel matrix; an output of the first encoder obtained after at least one channel matrix in the first matrix group is input into the first encoder is used to generate the first channel information.

In one embodiment, the meaning of the phrase that “an output of the first encoder is used to generate the first channel information” comprises: an output of the first encoder comprises the first channel information.

In one embodiment, the meaning of the phrase that “an output of the first encoder is used to generate the first channel information” comprises: the first channel information is an output of the quantizer obtained by using the output of the first encoder as an input of the quantizer.

In one embodiment, the meaning of the phrase that “an output of the first encoder is used to generate the first channel information” comprises: the first channel information is an output of the function obtained by using the output of the first encoder as the input of the function.

In one embodiment, the meaning of the phrase that “an output of the first encoder is used to generate the first channel information” comprises: the first channel information is an output of the transformation obtained by using the output of the first encoder as the input of the transformation.

In one embodiment, the first matrix group is only available for the first node.

In one embodiment, the meaning of the phrase that “the first matrix group is only available for the first node” comprises: in both the first node and a transmitter of the first information block, the first matrix group is only available for the first node.

In one embodiment, the meaning of the phrase that “the first matrix group is only available for the first node” comprises: the first matrix group is generated at the first node, and the first node transmits control information that can be used to fully recover the first matrix group not through an air interface.

In one embodiment, the meaning of the phrase that “the first matrix group is only available for the first node” comprises: the first matrix group is generated at the first node, and a transmitter of the first information block does not obtain the first matrix group.

In one embodiment, the first matrix group is only available for the first node.

### Embodiment 7

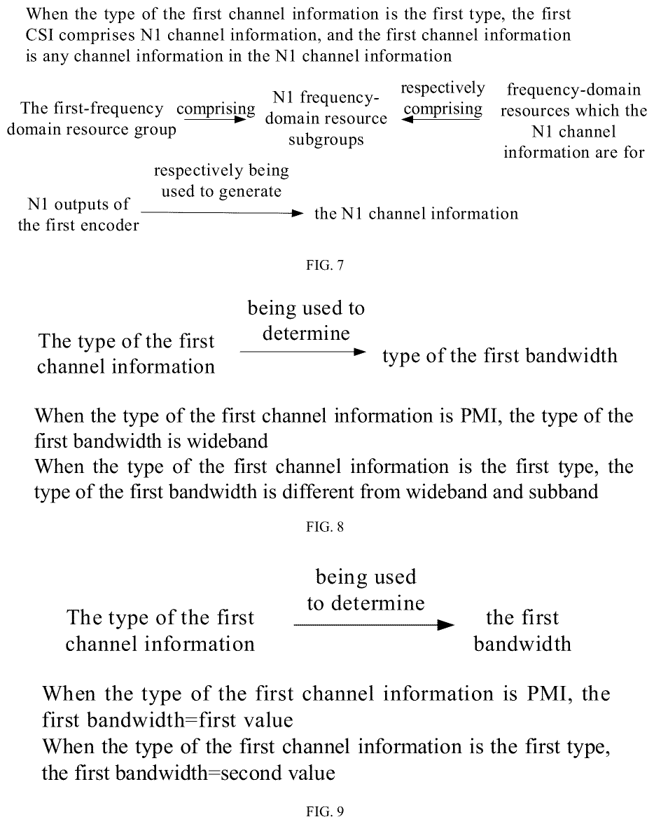

Embodiment 7 illustrates a schematic diagram of N1 channel information according to one embodiment of the present application, as shown in FIG. 7.

In embodiment 7, a first frequency-domain resource group comprises frequency-domain resources which the first CSI is for; when the type of the first channel information is the first type, the first CSI comprises N1 channel information, the first channel information is any channel information in the N1 channel information, the first frequency-domain resource group comprises N1 frequency-domain resource subgroups, and frequency-domain resources which the N1 channel information are respectively for comprise the N1 frequency-domain resource subgroups respectively, N1 being a positive integer greater than 1; N1 outputs of the first encoder are respectively used to generate the N1 channel information.

In one embodiment, N1 outputs of the first encoder are respectively taken the N1 channel matrixes as inputs, and a measurement on the first RS resource set is used to generate N1 channel matrixes.

In one embodiment, the first matrix group comprises N1 channel matrixes, the N1 channel matrixes respectively input the first encoder to obtain N1 outputs of the first encoder, and the N1 outputs are respectively used to generate the N1 channel information.

In one embodiment, the N1 channel matrixes are respectively targeted at the N1 frequency-domain resource subgroups.

In one embodiment, the measurement for the first RS resource set is used to generate a first matrix group, and the first matrix group comprises at least one channel matrix; the first matrix group is used to generate N1 channel information.

In one embodiment, the first channel information is any channel information in the N1 channel information, and a first channel matrix in the first matrix group is used to generate the first channel information.

In one subembodiment of the above embodiment, the first channel matrix comprises at least one channel matrix in the first matrix group.

In one subembodiment of the above embodiment, the first channel matrix is a channel matrix in the first matrix group.

Typically, the specific algorithm used to compute a first matrix group is self-determined by the manufacturer of the first node, or is implementation-related.

In one embodiment, the specific implementation method of the first matrix group is implemented by the hardware device manufacturer themselves.

In one embodiment, at least one channel matrix estimated for the measurement of the first RS resource set consists of the first matrix group.

In one embodiment, at least one eigenvector of at least one channel matrix estimated for the measurement of the first RS resource set consists of the first matrix group.

In one embodiment, at least one precoding vector or precoding matrix that has most similar or has minimum NMSE to a channel estimated by the measurement for the first RS resource set is selected in a candidate codebook to consist a first matrix group.

In one embodiment, the first channel matrix comprises at least one vector, and each element in the at least one vector comprises a complex number.

In one embodiment, the first channel matrix comprises at least one vector, and each element in the at least one vector comprises a phase.

In one embodiment, the first channel matrix comprises at least one vector, each element in the at least one vector comprises a phase, and all elements in each vector in the at least one vector have a same amplitude.

In one embodiment, the first channel matrix comprises at least one eigenvector.

In one embodiment, the first channel matrix comprises at least one eigenvector as well as an eigenvalue corresponding to each eigenvector in the at least one eigenvector.

In one embodiment, each element in the first channel matrix is a channel impulse response between a transmitting antenna port and a receiving antenna.

In one embodiment, each element in the first channel matrix is a channel impulse response on an RB (resource block) or sub-band between a transmitting antenna port and a receiving antenna.

Typically, when the type of the first channel information is the first type, the first channel information is generated based on artificial intelligence methods.

In one embodiment, the first channel matrix is a codebook-based precoding matrix.

In one embodiment, when the type of the first channel information is the first type, the first channel matrix is an output obtained after inputting the first channel information into a first reference decoder, and the first reference decoder is only available to the first node.

In one embodiment, an input of the first decoder comprises a first recovery channel matrix.

In one embodiment, the second receiver utilizes a first decoder to generate a first recovery channel matrix.

In one embodiment, the first channel information is input to the first decoder after being de-quantized.

In one embodiment, the first channel information is input to the first decoder after being de-quantized.

In one embodiment, the meaning of the phrase that “the first channel information is used to generate an input of a first decoder” comprises: an input of the first decoder comprises the first channel information.

In one embodiment, the meaning of the phrase of “being used to generate an input of a first decoder” comprises: an input of the first decoder comprises an output of the first channel information after being input a function.

In one embodiment, the meaning of the phrase that “the first channel information is used to generate an input of a first decoder” comprises: an input of the first decoder comprises a result of the first channel information after transformation.

In one embodiment, the first reference decoder is the same as the first decoder.

In one embodiment, the first reference decoder is different from the first decoder.

In one embodiment, the above method allows the first node and the second node to use different decoders to process the first channel information, improving the implementation flexibility of hardware vendors.

In one embodiment, the first reference decoder is based on artificial intelligence.

In one embodiment, the above method allows the first node and the second node to use different decoders to process the first channel information, improving the implementation flexibility of hardware vendors.

In one embodiment, the training for generating the first encoder is performed by the first node.

In one embodiment, the training for generating the first encoder is performed by the second node.

In one embodiment, the training for generating the first encoder is used to generate the first decoder.

In one embodiment, the first channel matrix is a non-codebook based precoding matrix obtained by measuring the first RS resource set.

In one embodiment, the first channel matrix is for a first frequency-domain resource subgroup, the first frequency-domain resource subgroup is one of the N1 frequency-domain resource subgroups, and the first channel matrix consists of a channel matrix of at least one sub-band comprised in the first frequency-domain resource subgroup.

In one embodiment, the first channel matrix consists of a channel matrix of at least one sub-band.

In one embodiment, a generation of the first channel matrix adopts traditional non-artificial intelligence methods.

In one embodiment, the first channel matrix is a codebook-based precoding matrix obtained by measuring the first RS resource set.

In one embodiment, a codebook to which the first channel matrix belongs is a codebook indicated by PMI.

In one embodiment, the first channel matrix is a precoding matrix indicated by the first channel information based on the assumption that the type of the first channel information is PMI.

In one embodiment, the first channel matrix is an output obtained after the first channel information is input to a first reference decoder.

In one embodiment, the first reference decoder is only available for the first node.

In one embodiment, the first channel information is used to recover the first channel matrix.

In one embodiment, the first channel matrix is a precoding matrix in Type I codebook.

In one embodiment, the first channel matrix is a precoding matrix in Type II codebook.

In one embodiment, the first channel matrix is a precoding matrix in enhanced type II codebook.

### Embodiment 8

Embodiment 8 illustrates a schematic diagram of a type of a first bandwidth according to one embodiment of the present application, as shown in FIG. 8.

In embodiment 8, the type of the first channel information is used to determine a type of the first bandwidth; when the type of the first channel information is PMI, the type of the first bandwidth is wideband; when the type of the first channel information is the first type, the type of the first bandwidth is different from wideband and sub-band.

In one embodiment, when the type of the first channel information is the first type, the first bandwidth is greater than a sub-band and less than a wideband.

### Embodiment 9

Embodiment 9 illustrates a flowchart of a relation of a first bandwidth and a type of first channel information according to one embodiment of the present application, as shown in FIG. 9.

In embodiment 9, the type of the first channel information is used to determine the first bandwidth; when the type of the first channel information is PMI, the first bandwidth is equal to a first value; when the type of the first channel information is the first type, the first bandwidth is equal to a second value.

In one embodiment, the first value is a bandwidth of the first frequency-domain resource group.

In one embodiment, the second value is an input bandwidth of the first encoder.

In one embodiment, the second value is less than the first value.

In one embodiment, the second value is not greater than the first value.

In one embodiment, the second value is related to the first encoder.

In one embodiment, the second value is a parameter of the first encoder.

In one embodiment, the second value is pre-defined.

In one embodiment, the second value is fixed.

In one embodiment, the second value is configurable.

In one embodiment, the second value is reported by the first node to a receiver of the first CSI.

In one embodiment, the second value is reported by the first node to a transmitter of the first RS resource set.

In one embodiment, the second value is related to the UE capability.

In one embodiment, the first value and second value are both positive integers.

In one embodiment, the first value and second value are both positive real numbers.

In one embodiment, a unit for measurement of the first bandwidth, a unit for measurement of the second bandwidth, a unit for measurement of the first value, and a unit for measurement of the second value are all Hz.

In one embodiment, a unit for measurement of the first bandwidth, a unit for measurement of the second bandwidth, a unit for measurement of the first value, and a unit for measurement of the second value are all RB.

In one embodiment, an input of the first decoder comprises a first recovery channel matrix.

In one embodiment, the second receiver utilizes a first decoder to generate a first recovery channel matrix.

In one embodiment, the first channel information is input to the first decoder after being de-quantized.

In one embodiment, the first channel information is input to the first decoder after being de-quantized.

In one embodiment, the meaning of the phrase that “the first channel information is used to generate an input of a first decoder” comprises: an input of the first decoder comprises the first channel information.

In one embodiment, the meaning of the phrase of “being used to generate an input of a first decoder” comprises: an input of the first decoder comprises an output of the first channel information after being input a function.

In one embodiment, the meaning of the phrase that “the first channel information is used to generate an input of a first decoder” comprises: an input of the first decoder comprises a result of the first channel information after being transformed.

In one embodiment, the first reference decoder is the same as the first decoder.

In one embodiment, the first reference decoder is different from the first decoder.

In one embodiment, the above method allows the first node and the second node to use different decoders to process the first channel information, improving the implementation flexibility of hardware manufacturers.

### Embodiment 10

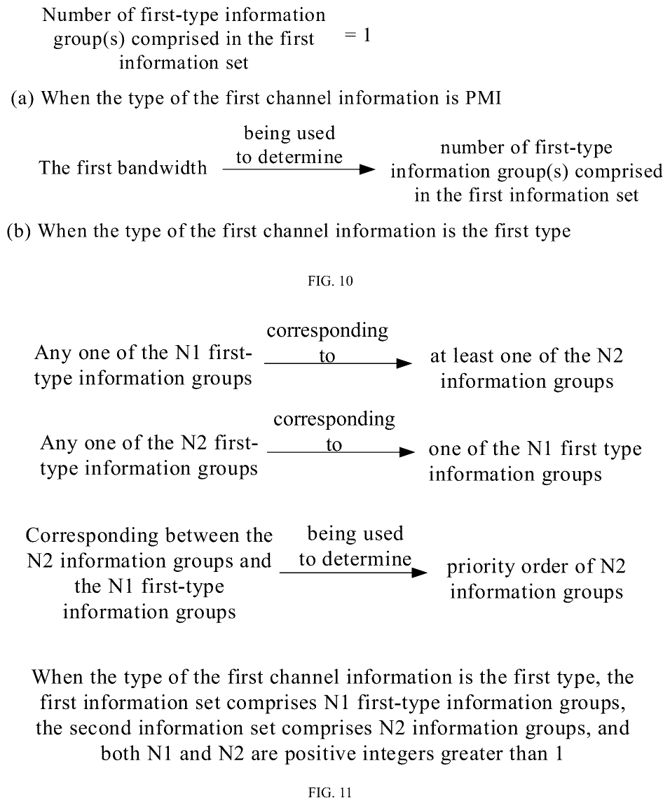

Embodiment 10 illustrates a schematic diagram of a number of first-type information group(s) comprised in a first information set according to one embodiment of the present application, as shown in FIG. 10.

In embodiment 10, when the type of the first channel information is PMI, the number of the first-type information group(s) comprised in the first information set is equal to 1; when the type of the first channel information is the first type, the first bandwidth is used to determine the number of the first-type information group(s) comprised in the first information set.

In one embodiment, when the type of the first channel information is the first type, a number of first-type information group(s) comprised in the first information set is equal to or greater than 1.

In one embodiment, the meaning of the phrase that “the first bandwidth is used to determine a number of first-type information group(s) comprised in the first information set” comprises: the first bandwidth is used to determine whether a number of the first-type information group(s) comprised in the first information set is equal to 1 or greater than 1.

In one embodiment, the meaning of the phrase that “the first bandwidth is used to determine a number of first-type information group(s) comprised in the first information set” comprises: a first frequency-domain resource group comprises frequency-domain resources which the first CSI is for, and a bandwidth of the first frequency-domain resource group and the first bandwidth are used together to determine a number of first-type information group(s) comprised in the first information set.

In one embodiment, the meaning of the phrase that “the first bandwidth is used to determine a number of first-type information group(s) comprised in the first information set” comprises: a size relation of a bandwidth of the first frequency-domain resource group and the first bandwidth is used to determine a number of first-type information group(s) comprised in the first information set.

In one embodiment, the meaning of the phrase that “the first bandwidth is used to determine a number of first-type information group(s) comprised in the first information set” comprises: whether the first bandwidth is not less than a bandwidth of the first frequency-domain resource group is used to determine a number of first-type information group(s) comprised in the first information set.

In one embodiment, the meaning of the phrase that “the first bandwidth is used to determine a number of first-type information group(s) comprised in the first information set” comprises: when the first bandwidth is not less than a bandwidth of the first frequency-domain resource group, a number of the first-type information group(s) comprised in the first information set is equal to 1; when the first bandwidth is less than a bandwidth of the first frequency-domain resource group, a number of the first-type information group(s) comprised in the first information set is greater than 1.

In one embodiment, the meaning of the phrase that “the first bandwidth is used to determine a number of first-type information group(s) comprised in the first information set” comprises: when the first bandwidth is less than a bandwidth of the first frequency-domain resource group, the first frequency-domain resource group and the first bandwidth are used together to determine N1 frequency-domain resource subgroups, the first information set comprises N1 first-type information groups, and the N1 first-type information groups are respectively for the N1 frequency-domain resource subgroups.

In one embodiment, the meaning of the phrase that “the first frequency-domain resource group and the first bandwidth are used together to determine N1 frequency-domain resource subgroups” comprises: the first frequency-domain resource group is divided into N1 frequency-domain resource subgroups to ensure that bandwidths of all N1 frequency-domain resource subgroups are not greater than the first bandwidth.

In one embodiment, the meaning of the phrase that “the first frequency-domain resource group and the first bandwidth are used together to determine N1 frequency-domain resource subgroups” comprises: N1 is equal to a minimum integer not less than a ratio of a bandwidth of the first frequency-domain resource group to the first bandwidth.

### Embodiment 11

Embodiment 11 illustrates a schematic diagram of a priority ranking of N2 information groups according to one embodiment of the present application, as shown in FIG. 11.

In embodiment 11, when the type of the first channel information is the first type, the first information set comprises N1 first-type information groups, the second information set comprises N2 information groups, both N1 and N2 being positive integers greater than 1, any of the N1 first-type information groups corresponds to at least one of the N2 information groups, and any of the N2 information groups corresponds to one of the N1 first-type information groups, the corresponding between the N2 information groups and the N1 first-type information groups is used to determine a priority order of the N2 information groups.

In one embodiment, a priority of the N1 first-type information groups is higher than a priority of the N2 information groups.

In one embodiment, priorities of the N1 first-type information groups are the same.

In one embodiment, priorities of any two of the N2 information groups are different.

In one embodiment, a corresponding first-type information group and an information group in the second information set are a same output after through a first encoder.

In one embodiment, a first given information group is one of the N1 first-type information groups, and a second given information group is any information group corresponding to the first given information group in the second information set; the meaning of “the second given information group corresponding to the first given information group” comprises: frequency-domain resource targeted by the second given information group belong to frequency-domain resource targeted by the first given information group.

In one embodiment, a first given information group is one of the N1 first-type information groups, and a second given information group is any information group corresponding to the first given information group in the second information set; the meaning of “the second given information group corresponding to the first given information group” comprises: the first given information group and the second given information group are generated by a same output of the first encoder.

In one embodiment, a first given information group is one of the N1 first-type information groups, and a second given information group is any information group corresponding to the first given information group in the second information set; the meaning of “the second given information group corresponding to the first given information group” comprises: the first given information group and the second given information group belong to same channel information in the N1 channel information.

In one embodiment, the N1 first-type information groups respectively correspond to N1 indexes, a first reference information set comprises all first-type information groups whose corresponding indexes are even among the N1 first-type information groups, and a second reference information set comprises all first-type information groups whose corresponding indexes are odd among the N1 first-type information groups.

In one embodiment, the N1 first-type information groups respectively correspond to N1 indexes, the N1 indexes are divided into a first index group and a second index group, a first reference information set comprises all first-type information groups whose corresponding indexes belong to the first index group in the N1 first-type information groups, and a second reference information set comprises all first-type information groups whose corresponding indexes belong to the second index group in the N1 first-type information groups.

In one embodiment, the N1 indexes are non-negative integers.

In one embodiment, the N1 indexes are positive integers.

In one embodiment, the N1 indexes are 0, 1, . . . , N1-1.

In one embodiment, the N1 indexes are 1, 2, . . . , N1.

In one embodiment, a first target information set comprises all information groups corresponding to a first-type information group in the first reference information set among the N2 information groups, and a second target information set comprises all information groups corresponding to a first-type information group in the second reference information set among the N2 information groups.

In one embodiment, N2 is equal to 2, and a priority of the first target information set is higher than a priority of the second target information set.

In one embodiment, N2 is equal to 2, and a priority of the first target information set is lower than a priority of the second target information set.

In one embodiment, N2 is equal to 2, and priorities of all information groups corresponding to a first-type information group in the first reference information set among the N2 information groups are the same, and priorities of all information groups corresponding to a first-type information group in the second reference information set among the N2 information groups are the same.

In one embodiment, the N2 information groups correspond to N2 indexes respectively; a first information subset comprises all information groups whose corresponding indexes are even in the first target information set, and a second information subset comprises all information groups whose corresponding indexes are odd in the first target information set; a third information subset comprises all information groups whose corresponding indexes are even in the second target information set, and a fourth information subset comprises all information groups whose corresponding indexes are odd in the second target information set.

In one embodiment, the N2 information groups correspond to N2 indexes respectively; all indexes corresponding to the first target information set are divided into a third index group and a fourth index group, a first information subset comprises all information groups whose corresponding indexes belong to the third index group in the first target information set, and a second information subset comprises all information groups whose corresponding indexes belong to the fourth index group in the first target information set; all indexes corresponding to the second target information set are divided into a fifth index group and a sixth index group, a third information subset comprises all information groups whose corresponding indexes belong to the fifth index group in the second target information set, and a fourth information subset comprises all information groups whose corresponding indexes belong to the sixth index group in the second target information set.

In one embodiment, the N2 indexes are non-negative integers.

In one embodiment, the N2 indexes are positive integers.

In one embodiment, the N2 indexes are 0, 1, . . . , N2-1.

In one embodiment, the N2 indexes are 1, 2, . . . , N2.

In one embodiment, in a descending order of priority is: the first information subset, the second information subset, the third information subset, and the fourth information subset.

In one embodiment, in an ascending order of priority is: the first information subset, the second information subset, the third information subset, and the fourth information subset.

In one embodiment, priorities of all information groups comprised in the first information subset are the same, priorities of all information groups comprised in the second information subset are the same, priorities of all information groups comprised in the third information subset are the same, and priorities of all information groups comprised in the fourth information subset are the same.

In one embodiment, in a descending order of priority is: the first information subset, the third information subset, the second information subset, and the fourth information subset.

In one embodiment, in an ascending order of priority is: the first information subset, the third information subset, the second information subset, and the fourth information subset.

### Embodiment 12

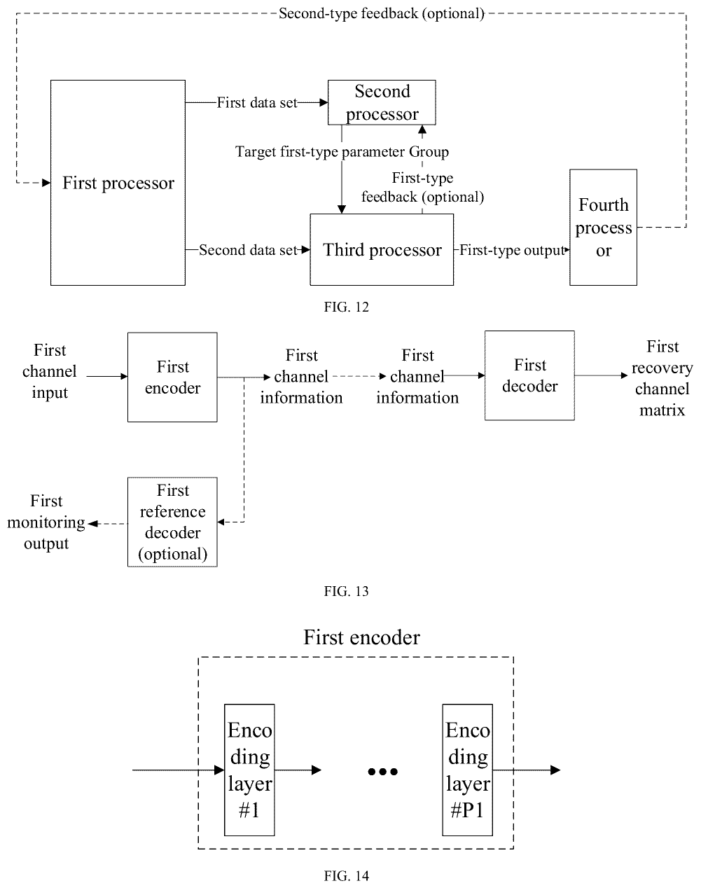

Embodiment 12 illustrates a schematic diagram of an artificial intelligence processing system according to one aspect of the present application, as shown in FIG. 12. FIG. 12 comprises a first processor, a second processor, a third processor, and a fourth processor.

In Embodiment 12, the first processor transmits a first data set to the second processor, and the second processor generates a target first-type parameter group according to the first data set, the second processor transmits the generated target first-type parameter group to the third processor, and the third processor processes a second data set using the target first-type parameter group to obtain a first-type output, and then transmits the first-type output to the fourth processor.

In one embodiment, the third processor transmits a first-type feedback to the second processor, and the first-type feedback is used to trigger a recalculation or update of the target first-type parameter group.

In one embodiment, the fourth processor transmits a second-type feedback to the first processor, the second-type feedback is used to generate the first data set or the second data set, or the second-type feedback is used to trigger a transmission of the first data set or second data set.

In one embodiment, the first processor generates the first data set and the second data set according to a measurement for the first radio signal, and the first radio signal comprises the first RS resource set in the present application.

In one embodiment, the first processor and the third processor belong to a first node, the fourth processor belongs to the second node, and the first-type output comprises first channel information of a first type.

In one embodiment, the second processor belongs to a first node.

The above embodiment avoids passing the first data set to a second node.

In one embodiment, the second processor belongs to a second node.

The above embodiments reduce the complexity of the first node.

In one embodiment, the first data set is training data, the second data set is interference data, the second processor is used for training model, and the trained model is described by the target first-type parameter group.

In one embodiment, the third processor constructs a model according to the target first-type parameter set, and then inputs the second data set into the constructed model to obtain the first-type output, which is then transmitted to the fourth processor.

In one subembodiment of the above embodiment, the third processor comprises the first encoder of the present application, the first encoder is described by the target first-type parameter group, and a generation of the first class output is executed by the first encoder.

In one embodiment, the third processor calculates an error of the first-type output and actual data to determine the performance of the trained model; the actual data is data received after the second data set and transmitted by the first processor.

The above embodiments are particularly suitable for predicting relevant reportings.

In one embodiment, the third processor recovers a reference data set according to the first-type output, and an error of the reference data set and the second data set is used to generate the first-type feedback.

Recovery of the reference data set usually adopts an inverse operation similar to the target first-type parameter group, and the above embodiments are particularly suitable for CSI compression related reporting.

In one embodiment, the first-type feedback is used to reflect the performance of the trained model; when the performance of the trained model cannot meet requirements, the second processing opportunity recalculates the target first-type parameter group.

In one subembodiment of the above embodiment, the third processor comprises a first reference decoder of the present application, and the first reference decoder is described by the target first-type parameter group. An input of the first reference decoder comprises the first-type output, and an output of the first reference decoder comprises the reference data set.

Typically, the performance of the trained model is considered unsatisfactory when the error is too large or is not updated for too long.

In one embodiment, the third processor belongs to a second node, and the first node reports the target first-type parameter group to the second node.

In one embodiment, when a type of the first channel information is the first type, the first channel information in the present application is generated by the third processor.

In one embodiment, when a type of the first channel information is the first type, the N1 channel information in the present application is generated by the third processor.

In one embodiment, when a type of the first channel information is the first type, the first information set and the second information set in the present application are generated by the third processor.

In one embodiment, when a type of the first channel information is the first type, partial information in the first information set in the present application is generated by the third processor.

In one embodiment, when a type of the first channel information is the first type, partial information in the second information set in the present application is generated by the third processor.

In one embodiment, when a type of the first channel information is the first type, the first-type information group in the present application is generated by the third processor.

In one embodiment, when a type of the first channel information is the first type, partial or all information in the first CSI in the present application is generated by the third processor.

### Embodiment 13

Embodiment 13 illustrates a flowchart of a transmission of first channel information according to one embodiment of the present application, as shown in FIG. 13. In FIG. 8, a first reference decoder is optional.

In Embodiment 8, a first encoder and a first decoder belong to a first node and a second node respectively.

The first receiver generates the first channel information using a first encoder; herein, an input of the first encoder comprises the first channel input, and the first encoder is obtained by training; the first channel input is obtained according to a measurement for a first reference signal;
the first node feeds back the first channel information to the second node through an air interface;
the second receiver generates a first recovery channel matrix using a first decoder; herein, an input of the first decoder comprises the first channel information, and the first decoder is obtained through training.

In one embodiment, the first encoder belongs to a first receiver.

In one embodiment, the first encoder belongs to a first transmitter.

In one embodiment, the first encoder belongs to at least one of a first receiver or a first transmitter.

In one embodiment, the first decoder belongs to a second receiver.

In one embodiment, the first channel input is a channel parameter matrix, or a matrix consists of at least one eigenvector.

In one embodiment, the first channel input comprises the first channel matrix in the present application.

In one embodiment, the first channel input comprises the first matrix group in the present application.

In one embodiment, the first receiver also comprises a first reference decoder, an input of the first reference decoder comprises the first channel information, and an output of the first reference decoder comprises a first monitoring output.

In one embodiment, the first monitoring output comprises the first channel matrix, and the first reference decoder and the first decoder cannot be considered the same.

In one embodiment, the first reference decoder is the same as the first decoder.

In one embodiment, the first reference decoder is different from the first decoder.

In one embodiment, the first reference decoder and the first decoder are independently generated or maintained.

In the above embodiments, the first reference decoder and the first decoder may be independently generated or maintained, so that although they are both intended to perform an inverse operation of the first encoder, the two may be only approximate.

In one embodiment, the first recovery channel matrix is known only to the second node.

In one embodiment, the first recovery channel matrix cannot be considered identical to the first channel matrix.

In one embodiment, when the first reference decoder and the first decoder are the same, the first recovery channel matrix and the first channel matrix are the same.

In one embodiment, when the first reference decoder and the first decoder are different, the first recovery channel matrix and the first channel matrix are different.

In one embodiment, when the first reference decoder and the first decoder are different, the first recovery channel matrix and the first channel matrix cannot be considered the same.

In one embodiment, the first receiver comprises a third processor in embodiment 12.

In one embodiment, the first transmitter comprises a third processor in embodiment 12.

In one embodiment, at least one of the first receiver or the first transmitter comprises a third processor in embodiment 12.

In one embodiment, the first channel input belongs to the second data set in embodiment 12.

In one embodiment, the training for the first encoder is used to obtain the first encoder.

In one embodiment, the training for the first encoder is used to obtain the first encoder and the first reference decoder.

In one embodiment, the training of the first encoder is performed at the first node.

In one embodiment, the training of the first encoder is performed by the second node.

### Embodiment 14

Embodiment 14 illustrates a schematic diagram of a first encoder according to one embodiment of the present application, as shown in FIG. 14. In FIG. 14, the first encoder comprises P1 encoding layers, namely encoding layers #1, #2, . . . , #P1.

In one embodiment, P1 is 2, that is, the P1 encoding layers comprise encoding layer #1 and encoding layer #2, and the encoding layer #1 and encoding layer #2 are convolutional layer and fully-connected layer respectively; at the convolutional layer, at least one convolutional kernel is used to convolve the first channel input to generate a corresponding feature map, and at least one feature map output by the convolution layer is reshaped into a vector and input to the fully-connected layer; the fully-connected layer converts the vector into the first channel information in the present application. For a more detailed description, refer to CNN-related technical literature, e.g., Chao-Kai Wen, Deep Learning for Massive MIMO CSI Feedback, IEEE WIRELESS COMMUNICATIONS LETTERS, VOL. 7, NO. 5, Oct. 2018 and etc.

In one embodiment, P1 is 3, that is, the P1 encoding layers comprise a fully-connected layer, a convolutional layer and a pooling layer.

### Embodiment 15

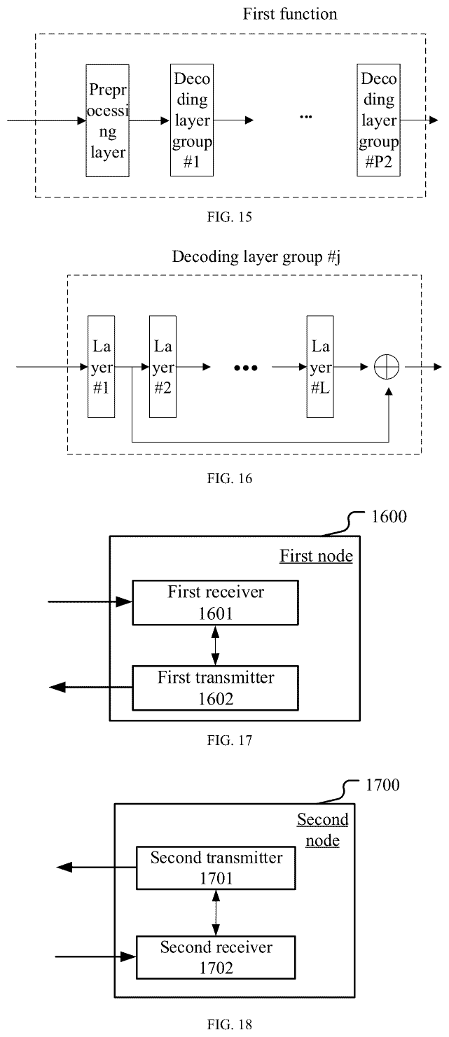

Embodiment 15 illustrates a schematic diagram of a first function according to one embodiment of the present application, as shown in FIG. 15. In FIG. 15, the first function comprises a pre-processing layer and P2 decoding layer groups, namely decoding layer groups #1, #2, . . . , #P2. Each decoding layer group comprises at least one decoding layer.

The structure of the first function is applicable to a first decoder and a first reference decoder in embodiment 13.

In one embodiment, the pre-processing layer is a fully-connected layer that expands a size of the first channel information to a size of the first channel input.

In one embodiment, any two of the P2 decoding layer groups have a same structure, the structure comprises a number of decoding layers comprised, a size of input parameters and a size of output parameters of each decoding layer comprised and etc.

In one embodiment, the first node indicates P2 and the structure of the decoding layer group to the second node.

In one embodiment, the second node indicates P2 and the structure of the decoding layer group to the first node.

In one embodiment, the first node indicates other parameters of the first function to the second node.

In one embodiment, the second node indicates other parameters of the first function to the first node.

In one embodiment, the other parameters comprise at least one of a threshold of an activation function, a size of a convolution kernel, a step-size of a convolution kernel, and a weight between feature maps.

### Embodiment 16

Embodiment 16 illustrates a schematic diagram of a decoding layer group according to one embodiment of the present application, as shown in FIG. 16. In FIG. 16, the decoding layer group #j comprises L layers, that is, layers #1, #2, . . . , #L; the decoding layer group is any one of the P2 decoding layer groups.

In one embodiment, L is 4, the first layer of the L layers is an input layer, and the last three layers of the L layers are all convolutional layers, and for a more detailed description, refer to CNN-related technical literature, e.g., Chao-Kai Wen, Deep Learning for Massive MIMO CSI Feedback, IEEE WIRELESS COMMUNICATIONS LETTERS, VOL. 7, NO. 5, Oct. 2018 and etc.

In one embodiment, the L layers comprise at least one convolutional layer and one pooling layer.

### Embodiment 17

Embodiment 17 illustrates a structure block diagram of a processor in a first node according to one embodiment of the present application, as shown in FIG. 17. In FIG. 17, a processor 1600 in a first node comprises a first receiver 1601 and a first transmitter 1602.

In one embodiment, the first node 1600 is a UE.

In one embodiment, the first transmitter 1602 comprises at least one of the antenna 452, the transmitter/receiver 454, the multi-antenna transmitting processor 457, the transmitting processor 468, the controller/processor 459, the memory 460 or the data source 467 in FIG. 4 of the present application.

In one embodiment, the first transmitter 1602 comprises the antenna 452, the transmitter/receiver 454, the multi-antenna transmitting processor 457, the transmitting processor 468, the controller/processor 459, the memory 460 and the data source 467 in FIG. 4 of the present application.

In one embodiment, the first receiver 1601 comprises at least the first five of the antenna 452, the receiver 454, the multi-antenna receiving processor 458, the receiving processor 456, the controller/processor 459, the memory 460 and the data source 467 in FIG. 4 of the present application.

In one embodiment, the first receiver 1601 comprises at least the first four of the antenna 452, the receiver 454, the multi-antenna receiving processor 458, the receiving processor 456, the controller/processor 459, the memory 460 and the data source 467 in FIG. 4 of the present application.

In one embodiment, the first receiver 1601 comprises at least the first three of the antenna 452, the receiver 454, the multi-antenna receiving processor 458, the receiving processor 456, the controller/processor 459, the memory 460 and the data source 467 in FIG. 4 of the present application.
the first receiver 1601 receives a first information block;
the first transmitter 1602 transmits first CSI;

In embodiment 17, the first information block is used to indicate a first RS resource set, the first RS resource set comprises at least one RS resource; a measurement on the first RS resource set is used to generate the first CSI, the first CSI comprises a first information set and a second information set, the first information set comprises at least one first-type information group, and the second information set comprises at least one information group; both the first-type information group and any information group in the second information set comprise at least one CSI report quantity, the first-type information group corresponds to a first bandwidth, and a priority of the first-type information group is higher than a priority of any information group in the second-type information set; first channel information belongs to the first CSI, and a type of the first channel information is either PMI or first type, where the PMI is codebook-based and the first type is non-codebook-based; the type of the first channel information is used to determine a number of the first-type information group(s) comprised in the first information set.

In one embodiment, when the type of the first channel information is the first type, a measurement on the first RS resource set is used to generate an input of a first encoder, and an output of the first encoder is used to generate the first channel information.

In one embodiment, a first frequency-domain resource group comprises frequency-domain resources which the first CSI is for; when the type of the first channel information is the first type, the first CSI comprises N1 channel information, the first channel information is any channel information in the N1 channel information, the first frequency-domain resource group comprises N1 frequency-domain resource subgroups, and frequency-domain resources which the N1 channel information are respectively for comprise the N1 frequency-domain resource subgroups respectively, N1 being a positive integer greater than 1; N1 outputs of the first encoder are respectively used to generate the N1 channel information.

In one embodiment, the type of the first channel information is used to determine a type of the first bandwidth; when the type of the first channel information is PMI, the type of the first bandwidth is wideband; when the type of the first channel information is the first type, the type of the first bandwidth is different from wideband and sub-band.

In one embodiment, the type of the first channel information is used to determine the first bandwidth; when the type of the first channel information is PMI, the first bandwidth is equal to a first value; when the type of the first channel information is the first type, the first bandwidth is equal to a second value.

In one embodiment, when the type of the first channel information is PMI, the number of the first-type information group(s) comprised in the first information set is equal to 1; when the type of the first channel information is the first type, the first bandwidth is used to determine the number of the first-type information group(s) comprised in the first information set.

In one embodiment, when the type of the first channel information is the first type, the first information set comprises N1 first-type information groups, the second information set comprises N2 information groups, both N1 and N2 being positive integers greater than 1, any of the N1 first-type information groups corresponds to at least one of the N2 information groups, and any of the N2 information groups corresponds to one of the N1 first-type information groups, the corresponding between the N2 information groups and the N1 first-type information groups is used to determine a priority order of the N2 information groups.

### Embodiment 18

Embodiment 18 illustrates a structure block diagram of a processor in a second node according to one embodiment of the present application, as shown in FIG. 18. In FIG. 18, a processor 1700 in the second node comprises a second transmitter 1701 and a second receiver 1702.

In one embodiment, the second node 1700 is a base station.

In one embodiment, the second transmitter 1701 comprises the antenna 420, the transmitter 418, the transmitting processor 416 and the controller/processor 475.

In one embodiment, the second transmitter 1701 comprises the antenna 420, the transmitter 418, the multi-antenna transmitting processor 471, the transmitting processor 416 and the controller/processor 475.

In one embodiment, the second transmitter 1701 comprises the antenna 420, the transmitter 418, the transmitting processor 416 and the controller/processor 475.

In one embodiment, the second transmitter 1701 comprises the antenna 420, the transmitter 418, the multi-antenna transmitting processor 471, the transmitting processor 416 and the controller/processor 475.

In one embodiment, the second receiver 1702 comprises the antenna 420, the receiver 418, the multi-antenna receiving processor 472, the receiving processor 470 and the controller/processor 475.

In one embodiment, the second receiver 1702 comprises the controller/processor 475.

The second transmitter 1701 transmits a first information block;
the second receiver 1702 receives first CSI;

In embodiment 18, the first information block is used to indicate a first RS resource set, the first RS resource set comprises at least one RS resource; a measurement on the first RS resource set is used to generate the first CSI, the first CSI comprises a first information set and a second information set, the first information set comprises at least one first-type information group, and the second information set comprises at least one information group; both the first-type information group and any information group in the second information set comprise at least one CSI report quantity, the first-type information group corresponds to a first bandwidth, and a priority of the first-type information group is higher than a priority of any information group in the second-type information set; first channel information belongs to the first CSI, and a type of the first channel information is either PMI or first type, where the PMI is codebook-based and the first type is non-codebook-based; the type of the first channel information is used to determine a number of the first-type information group(s) comprised in the first information set.

In one embodiment, when the type of the first channel information is the first type, the first channel information is used to generate an input of a first decoder, and the first decoder is obtained through training.

In one embodiment, a first frequency-domain resource group comprises frequency-domain resources which the first CSI is for; when the type of the first channel information is the first type, the first CSI comprises N1 channel information, the first channel information is any channel information in the N1 channel information, the first frequency-domain resource group comprises N1 frequency-domain resource subgroups, and frequency-domain resources which the N1 channel information are respectively for comprise the N1 frequency-domain resource subgroups respectively, N1 being a positive integer greater than 1; N1 outputs of the first encoder are respectively used to generate the N1 channel information.

In one embodiment, the type of the first channel information is used to determine a type of the first bandwidth; when the type of the first channel information is PMI, the type of the first bandwidth is wideband; when the type of the first channel information is the first type, the type of the first bandwidth is different from wideband and sub-band.

In one embodiment, the type of the first channel information is used to determine the first bandwidth; when the type of the first channel information is PMI, the first bandwidth is equal to a first value; when the type of the first channel information is the first type, the first bandwidth is equal to a second value.

In one embodiment, when the type of the first channel information is PMI, the number of the first-type information group(s) comprised in the first information set is equal to 1; when the type of the first channel information is the first type, the first bandwidth is used to determine the number of the first-type information group(s) comprised in the first information set.

In one embodiment, when the type of the first channel information is the first type, the first information set comprises N1 first-type information groups, the second information set comprises N2 information groups, both N1 and N2 being positive integers greater than 1, any of the N1 first-type information groups corresponds to at least one of the N2 information groups, and any of the N2 information groups corresponds to one of the N1 first-type information groups, the corresponding between the N2 information groups and the N1 first-type information groups is used to determine a priority order of the N2 information groups.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The user equipment, terminal and UE include but are not limited to Unmanned Aerial Vehicles (UAVs), communication modules on UAVs, telecontrolled aircrafts, aircrafts, diminutive airplanes, mobile phones, tablet computers, notebooks, vehicle-mounted communication equipment, wireless sensors, network cards, Internet of Things (IoT) terminals, RFID terminals, NB-IoT terminals, Machine Type Communication (MTC) terminals, enhanced MTC (eMTC) terminals, data card, network cards, vehicle-mounted communication equipment, low-cost mobile phones, low-cost tablets and other wireless communication devices. The UE and terminal in the present application include but not limited to unmanned aerial vehicles, communication modules on unmanned aerial vehicles, telecontrolled aircrafts, aircrafts, diminutive airplanes, mobile phones, tablet computers, notebooks, vehicle-mounted communication equipment, wireless sensor, network cards, terminals for Internet of Things, RFID terminals, NB-IoT terminals, Machine Type Communication (MTC) terminals, enhanced MTC (eMTC) terminals, data cards, low-cost mobile phones, low-cost tablet computers, etc. The base station or system device in the present application includes but is not limited to macro-cellular base stations, micro-cellular base stations, home base stations, relay base station, gNB (NR node B), Transmitter Receiver Point (TRP), and other radio communication equipment.

It will be appreciated by those skilled in the art that this disclosure can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, comprising:
a first receiver, receiving a first information block; and
a first transmitter, transmitting first Channel Status Information (CSI);
wherein the first information block is used to indicate a first RS (Reference Signal) resource set, the first RS resource set comprises at least one RS resource; a measurement on the first RS resource set is used to generate the first CSI, the first CSI comprises a first information set and a second information set, the first information set comprises at least one first-type information group, and the second information set comprises at least one information group; both the first-type information group and any information group in the second information set comprise at least one CSI report quantity, the first-type information group corresponds to a first bandwidth, and apriority of the first-type information group is higher than apriority of any information group in the second-type information set; first channel information belongs to the first CSI, and a type of the first channel information is either PMI (Precoding Matrix Indicator) or first type, where the PMI is codebook-based and the first type is non-codebook-based; the type of the first channel information is used to determine a number of the first-type information group(s) comprised in the first information set.

2. The first node according to claim 1, wherein
when the type of the first channel information is the first type, a measurement on the first RS resource set is used to generate an input of a first encoder, and an output of the first encoder is used to generate the first channel information;
or,
when the type of the first channel information is the first type, a measurement on the first RS resource set is used to generate an input of a first encoder, and an output of the first encoder is used to generate the first channel information; a first frequency-domain resource group comprises frequency-domain resources which the first CSI is for; when the type of the first channel information is the first type, the first CSI comprises N1 channel information, the first channel information is any channel information in the N1 channel information, the first frequency-domain resource group comprises N1 frequency-domain resource subgroups, and frequency-domain resources which the N1 channel information are respectively for comprise the N1 frequency-domain resource subgroups respectively, N1 being a positive integer greater than 1; N1 outputs of the first encoder are respectively used to generate the N1 channel information.

3. The first node according to claim 1, wherein
the type of the first channel information is used to determine a type of the first bandwidth; when the type of the first channel information is PMI, the type of the first bandwidth is wideband; when the type of the first channel information is the first type, the type of the first bandwidth is different from wideband and sub-band;
or,
the type of the first channel information is used to determine the first bandwidth; when the type of the first channel information is PMI, the first bandwidth is equal to a first value; when the type of the first channel information is the first type, the first bandwidth is equal to a second value.

4. The first node according to claim 1, wherein when the type of the first channel information is PMI, the number of the first-type information group(s) comprised in the first information set is equal to 1; when the type of the first channel information is the first type, the first bandwidth is used to determine the number of the first-type information group(s) comprised in the first information set.

5. The first node according to claim 1, wherein when the type of the first channel information is the first type, the first information set comprises N1 first-type information groups, the second information set comprises N2 information groups, both N1 and N2 being positive integers greater than 1, any of the N1 first-type information groups corresponds to at least one of the N2 information groups, and any of the N2 information groups corresponds to one of the N1 first-type information groups, the corresponding between the N2 information groups and the N1 first-type information groups is used to determine a priority order of the N2 information groups.

6. A second node for wireless communications, comprising:
a second transmitter, transmitting a first information; and
a second receiver, receiving first CSI;
wherein the first information block is used to indicate a first RS resource set, the first RS resource set comprises at least one RS resource; a measurement on the first RS resource set is used to generate the first CSI, the first CSI comprises a first information set and a second information set, the first information set comprises at least one first-type information group, and the second information set comprises at least one information group; both the first-type information group and the second information set comprise at least one CSI report quantity, the first-type information group corresponds to a first bandwidth, and a priority of the first-type information group is higher than a priority of any information group in the second-type information set; first channel information belongs to the first CSI, and a type of the first channel information is either PMI or first type, where the PMI is codebook-based and the first type is non-codebook-based; the type of the first channel information is used to determine a number of the first-type information group(s) comprised in the first information set.

7. The second node according to claim 6, wherein
when the type of the first channel information is the first type, the first channel information is used to generate an input of a first decoder, and the first decoder is obtained by training;
or,
when the type of the first channel information is the first type, the first channel information is used to generate an input of a first decoder, and the first decoder is obtained by training; a first frequency-domain resource group comprises frequency-domain resources which the first CSI is for; when the type of the first channel information is the first type, the first CSI comprises N1 channel information, the first channel information is any channel information in the N1 channel information, the first frequency-domain resource group comprises N1 frequency-domain resource subgroups, and frequency-domain resources which the N1 channel information are respectively for comprise the N1 frequency-domain resource subgroups respectively, N1 being a positive integer greater than 1; N1 outputs of the first encoder are respectively used to generate the N1 channel information.

8. The second node according to claim 6, wherein
the type of the first channel information is used to determine a type of the first bandwidth; when the type of the first channel information is PMI, the type of the first bandwidth is wideband; when the type of the first channel information is the first type, the type of the first bandwidth is different from wideband and sub-band;
or,
the type of the first channel information is used to determine the first bandwidth; when the type of the first channel information is PMI, the first bandwidth is equal to a first value; when the type of the first channel information is the first type, the first bandwidth is equal to a second value.

9. The second node according to claim 6, wherein when the type of the first channel information is PMI, the number of the first-type information group(s) comprised in the first information set is equal to 1; when the type of the first channel information is the first type, the first bandwidth is used to determine the number of the first-type information group(s) comprised in the first information set.

10. The second node according to claim 6, wherein when the type of the first channel information is the first type, the first information set comprises N1 first-type information groups, the second information set comprises N2 information groups, both N1 and N2 being positive integers greater than 1, any of the N1 first-type information groups corresponds to at least one of the N2 information groups, and any of the N2 information groups corresponds to one of the N1 first-type information groups, the corresponding between the N2 information groups and the N1 first-type information groups is used to determine a priority order of the N2 information groups.

11. A method in a first node for wireless communications, comprising:
receiving a first information block; and
transmitting first CSI;
wherein the first information block is used to indicate a first RS resource set, the first RS resource set comprises at least one RS resource; a measurement on the first RS resource set is used to generate the first CSI, the first CSI comprises a first information set and a second information set, the first information set comprises at least one first-type information group, and the second information set comprises at least one information group; both the first-type information group and the second information set comprise at least one CSI report quantity, the first-type information group corresponds to a first bandwidth, and a priority of the first-type information group is higher than a priority of any information group in the second-type information set; first channel information belongs to the first CSI, and a type of the first channel information is either PMI or first type, where the PMI is codebook-based and the first type is non-codebook-based; the type of the first channel information is used to determine a number of the first-type information group(s) comprised in the first information set.

12. The method in a first node according to claim 11, wherein
when the type of the first channel information is the first type, a measurement on the first RS resource set is used to generate an input of a first encoder, and an output of the first encoder is used to generate the first channel information;
or,
when the type of the first channel information is the first type, a measurement on the first RS resource set is used to generate an input of a first encoder, and an output of the first encoder is used to generate the first channel information; a first frequency-domain resource group comprises frequency-domain resources which the first CSI is for; when the type of the first channel information is the first type, the first CSI comprises N1 channel information, the first channel information is any channel information in the N1 channel information, the first frequency-domain resource group comprises N1 frequency-domain resource subgroups, and frequency-domain resources which the N1 channel information are respectively for comprise the N1 frequency-domain resource subgroups respectively, N1 being a positive integer greater than 1; N1 outputs of the first encoder are respectively used to generate the N1 channel information.

13. The method in a first node according to claim 11, wherein
the type of the first channel information is used to determine a type of the first bandwidth; when the type of the first channel information is PMI, the type of the first bandwidth is wideband; when the type of the first channel information is the first type, the type of the first bandwidth is different from wideband and sub-band;
or,
the type of the first channel information is used to determine the first bandwidth; when the type of the first channel information is PMI, the first bandwidth is equal to a first value; when the type of the first channel information is the first type, the first bandwidth is equal to a second value.

14. The method in a first node according to claim 11, wherein when the type of the first channel information is PMI, the number of the first-type information group(s) comprised in the first information set is equal to 1; when the type of the first channel information is the first type, the first bandwidth is used to determine the number of the first-type information group(s) comprised in the first information set.

15. The method in a first node according to claim 11, wherein when the type of the first channel information is the first type, the first information set comprises N1 first-type information groups, the second information set comprises N2 information groups, both N1 and N2 being positive integers greater than 1, any of the N1 first-type information groups corresponds to at least one of the N2 information groups, and any of the N2 information groups corresponds to one of the N1 first-type information groups, the corresponding between the N2 information groups and the N1 first-type information groups is used to determine a priority order of the N2 information groups.

16. A method in a second node for wireless communications, comprising:
transmitting a first information block; and
receiving first CSI;
wherein the first information block is used to indicate a first RS resource set, the first RS resource set comprises at least one RS resource; a measurement on the first RS resource set is used to generate the first CSI, the first CSI comprises a first information set and a second information set, the first information set comprises at least one first-type information group, and the second information set comprises at least one information group; both the first-type information group and the second information set comprise at least one CSI report quantity, the first-type information group corresponds to a first bandwidth, and a priority of the first-type information group is higher than a priority of any information group in the second-type information set; first channel information belongs to the first CSI, and a type of the first channel information is either PMI or first type, where the PMI is codebook-based and the first type is non-codebook-based; the type of the first channel information is used to determine a number of the first-type information group(s) comprised in the first information set.

17. The method in a second node according to claim 16, wherein
when the type of the first channel information is the first type, the first channel information is used to generate an input of a first decoder, and the first decoder is obtained by training;
or,
when the type of the first channel information is the first type, the first channel information is used to generate an input of a first decoder, and the first decoder is obtained by training; a first frequency-domain resource group comprises frequency-domain resources which the first CSI is for; when the type of the first channel information is the first type, the first CSI comprises N1 channel information, the first channel information is any channel information in the N1 channel information, the first frequency-domain resource group comprises N1 frequency-domain resource subgroups, and frequency-domain resources which the N1 channel information are respectively for comprise the N1 frequency-domain resource subgroups respectively, N1 being a positive integer greater than 1; N1 outputs of the first encoder are respectively used to generate the N1 channel information.

18. The method in a second node according to claim 16, wherein
the type of the first channel information is used to determine a type of the first bandwidth; when the type of the first channel information is PMI, the type of the first bandwidth is wideband; when the type of the first channel information is the first type, the type of the first bandwidth is different from wideband and sub-band;
or,
the type of the first channel information is used to determine the first bandwidth; when the type of the first channel information is PMI, the first bandwidth is equal to a first value; when the type of the first channel information is the first type, the first bandwidth is equal to a second value.

19. The method in a second node according to claim 16, wherein when the type of the first channel information is PMI, the number of the first-type information group(s) comprised in the first information set is equal to 1; when the type of the first channel information is the first type, the first bandwidth is used to determine the number of the first-type information group(s) comprised in the first information set.

20. The method in a second node according to claim 16, wherein when the type of the first channel information is the first type, the first information set comprises N1 first-type information groups, the second information set comprises N2 information groups, both N1 and N2 being positive integers greater than 1, any of the N1 first-type information groups corresponds to at least one of the N2 information groups, and any of the N2 information groups corresponds to one of the N1 first-type information groups, corresponding between the N2 information groups and the N1 first-type information groups is used to determine a priority order of the N2 information groups.
